(19) United States
(12) Patent Application Publication
(10) Pub. No.: US 2014/0356884 A1
(43) Pub. Date: Dec. 4, 2014

(54) Boundary Layer Suction for Cell Capture

(71) Applicants: Sukant Mittal, Boston, MA (US); Mehmet Toner, Charlestown, MA (US)

(72) Inventors: Sukant Mittal, Boston, MA (US); Mehmet Toner, Charlestown, MA (US)

(21) Appl. No.: 14/240,261

(22) PCT Filed: Aug. 23, 2012
(86) PCT No.: PCT/US2012/052041

§ 371 Date: Jul. 25, 2014

Related U.S. Application Data
(60) Provisional application No. 61/526,511, filed on Aug. 23, 2011.

(51) Int. Cl. G01N 1/34

(52) U.S. Cl. CPC G01N 1/34
USPC 435/7.21

(57) ABSTRACT

Capturing particles includes introducing a fluid sample, which includes particles of a first type, into a first channel of a microfluidic device and flowing the fluid sample past a porous or partially porous membrane. The pores fluidly connect the first channel to a second channel, and the device further includes multiple binding moieties on a first side of the porous membrane adjacent to the first channel. The binding moieties are capable of binding to the first type of particles. Capturing particles also includes creating a pressure difference between the first and second channels to enable the fluid sample to flow from the first channel through the porous membrane into the second channel and to direct the particles toward the binding moieties, thereby capturing the first type of particles. In addition, by creating a modified capture surface that is impermeable near the walls of the channels, capture efficiencies and throughput can be increased.

### STATEMENT AS TO FEDERALLY SPONSORED RESEARCH

Funding for the work described herein was provided through National Institute of Health Federal Grant Number P41 EB002503, which is administered by the federal government, which has certain rights in the invention.

### TECHNICAL FIELD

The present disclosure relates to methods of using boundary layer suction for capturing cells and devices for performing the same.

### BACKGROUND

Microfluidic devices that capture cells have broad applications in biotechnology and medicine including, for example, in-vitro drug testing, disease diagnostics and studies of cell biology. Microfluidic platforms have been widely explored for cell separation and identification since samples can be precisely and reproducibly manipulated under well-defined conditions. At small length scales (e.g., on the order of millimeters or less), fluid dynamics are dominated by the high surface-to-volume ratio and interfacial phenomena. The interfacial effects at solid-fluid boundaries often govern local flow conditions and the performance of the microfluidic devices. For example, surface-based capture of analytes can be used for cell sorting and biomolecular sensing, enabling point-of-care diagnostics, personalized medicine and other biotechnological applications.

Although these effects have been exploited for a number of such applications, they set severe “speed limits” for analyte capture on solid surfaces as the capture processes can be compromised by several interfacial mechanisms. For example, the transport of analytes from the bulk to the surface may be too slow compared to the time spent in the microfluidic device. This is particularly problematic at the high flow rates needed to process large sample volumes due to rapid advection of analytes through the device, as well as poor mixing of viscous flows. In addition, in devices where surface reactions are desired, the speed with which analytes react with a surface may occur too slowly. For example, cells may have insufficient time to adhere specifically to binding moieties on the solid surface, while any molecular bonds that do form are pulled apart by shear forces. In contrast, when flow rates are decreased, cells are more likely to simply sediment from bulk solution to the surface, leading to a decrease both in selectivity as well as throughput. These competing mechanisms make it difficult to simultaneously achieve high cell separation throughput, capture efficiency, and selectivity. In practice, microfluidic devices are optimized for one of these parameters at the expense of the others.

### SUMMARY

The present disclosure is directed towards microfluidic devices that have one or more porous surfaces, e.g., membranes, functionalized with antibodies and that capture particles, such as mammalian or bacterial cells, with unprecedented efficiency, selectivity, and throughput. As used herein, a porous surface or membrane that has at least a portion or section that is porous. For example, all of the surface or membrane can be porous. Alternatively, the surface can be partly porous and partly non-porous. The effectiveness of these devises arises both from enhanced mass transport to the porous surface, as well as enhanced cell-surface interactions that promote dynamic rolling adhesion with high specificity. These cooperative mechanisms enable excellent performance even at extremely fast flow rates where no capture occurs on conventional solid surfaces. In addition, the disclosure describes using discontinuous nanoporous capture surfaces to avoid non-specific fouling that can block the capture surface to thwart specific target capture that occurs when processing complex biological mixtures such as blood.

In one aspect, the present disclosure describes microfluidic devices that include a first fluidic channel having a first channel inlet and a first channel outlet, a second fluidic channel having a second channel inlet and a second channel outlet, a porous membrane, e.g., a discontinuously permeable porous membrane, between the first fluidic channel and the second fluidic channel, and multiple binding moieties on a first side of the membrane facing the first fluidic channel. The porous membrane includes a plurality of pores, at least some of which, e.g., the majority of the pores or all of the pores, extend through the membrane from the first fluidic channel to the second fluidic channel to fluidly connect the first fluidic channel to the second fluidic during use.

In some implementations the multiple pores are configured and sized to prevent one or more cells in the first fluidic channel from flowing through the membrane into the second fluidic channel.

In some implementations, the multiple binding moieties bind, e.g., bind specifically, to a particular type of particle (such a specific type of cell) or binding partner (such as a ligand), and can include at least one of antibodies, antibody fragments, oligo- or polypeptides, nucleic acids, cellular receptors, ligands, aptamers, MHC-peptide monomers or oligomers, biotin, avidin, oligonucleotides, coordination complexes, synthetic polymers, and carbohydrates.

In another aspect, the present disclosure describes methods for capturing particles, the methods including introducing a fluid sample into a first channel of a microfluidic device, in which the fluid sample includes multiple particles of a first type, and flowing the fluid sample past a porous membrane, e.g., a discontinuously permeable porous membrane, in which the porous membrane includes multiple pores, each or most of the pores fluidly connecting the first channel to a second channel, and multiple binding moieties on a first side of the porous membrane adjacent to the first channel, where the multiple binding moieties are capable of binding, e.g., specifically binding, to the multiple particles of a first type. The methods further include creating a pressure difference between the first channel and the second channel to allow the fluid sample to flow from the first channel through pores in the porous membrane into the second channel and to direct the plurality of particles toward the multiple binding moieties, and capturing the particles of the first type on the binding moieties.

In some implementations, creating the pressure difference between the first channel and the second channel includes opening an outlet in the first channel and/or the second channel. Creating the pressure difference can include adjusting a size of the outlet in the second channel to be smaller than a size of the outlet in the first channel.

In some implementations, capturing the plurality of particles of the first type can include allowing the plurality of particles of the first type to bind to the binding moieties on the first side of the porous membrane.

In some implementations, the methods further include introducing a washing fluid into the first channel of the microfluidic device, flowing the washing fluid past the porous membrane, and preventing the washing fluid from flowing through the porous membrane into the second channel. Preventing the washing fluid from flowing through the porous membrane can include closing an outlet in the second channel.

In some implementations, a size of each particle of the first type is larger than a size of each pore.

In some implementations, the fluid sample further includes multiple particles of a second type. In some cases, the methods further include allowing the particles of the second type to pass from the first channel through the porous membrane into the second channel. A size of each particle of the second type can be smaller than a size of each pore.

In another aspect, the present disclosure describes a microfluidic device that includes a first fluidic channel arranged between a first channel inlet and a first channel outlet, a second fluidic channel arranged between a second channel inlet and a second channel outlet, and a discontinuously permeable porous membrane between the first fluidic channel and the second fluidic channel. The discontinuously permeable porous membrane includes a first section without pores, a second section without pores, and a third section between the first section and the second section. The third section includes a plurality of pores, at least some of the pores extending through the membrane from the first fluidic channel to the second fluidic channel to fluidly connect the first fluidic channel to the second fluidic channel. The micro fluidic device further includes a plurality of binding moieties on a first side of the membrane adjacent to the first fluidic channel.

As used herein, “specifically binds” or “binds specifically” means that one molecule, such as a binding moiety, e.g., an oligonucleotide or an antibody, binds preferentially to another molecule, such as a target molecule, e.g., a nucleic acid or a protein, in the presence of other molecules in a sample.

As used herein, “buffy coat” means the fraction of an anticoagulated blood sample after density gradient centrifugation that contains white blood cells and platelets.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods and examples are illustrative only and not intended to be limiting.

Other features and advantages will be apparent from the following detailed description, the figures and from the claims.

### BRIEF DESCRIPTION OF THE DRAWINGS

FIG. 1A is a perspective view of an example of a microfluidic device as described herein.

FIG. 1B is a schematic that illustrates a top view of another example of a microfluidic device described herein.

FIG. 1C is a schematic that illustrates a top view of microfluidic device that includes a discontinuously permeable porous membrane.

FIG. 1D is a scanning electron microscope (SEM) image of a porous membrane.

FIG. 1E is a schematic illustrating a top view of a multiplexed architecture of 8 parallel channels.

FIG. 2A is a schematic of an example of a microfluidic device during particle capture phase.

FIG. 2B is a schematic of an example of a microfluidic device during a washing phase.

FIG. 3 is a schematic illustrating a method of fabricating a microfluidic device as described herein.

FIGS. 4A and 4C are graphs of velocity versus time for cancer cells in a microfluidic device having an IgG functionalized surface and an EpCAM functionalized surface, respectively.

FIGS. 4B and 4D are graphs of displacement versus time for cancer cells in a microfluidic device having an IgG functionalized surface and an EpCAM functionalized surface, respectively.

FIGS. 5A and 5B are schematics depicting lumped resistor models for the microfluidic device.

FIGS. 6A and 6B are graphs showing experimental flow rates versus theoretical flow rates for the top and bottom channels for output tubing resistances comparable to the theoretical membrane resistance.

FIGS. 6C and 6D are graphs showing experimental flow rates versus theoretical flow rates for output tubing resistance that is ten times the average theoretical membrane resistance.

FIG. 7A is a graph that shows the theoretical and experimental results of permeation flux through a top channel of a micro fluidic device for different pressures.

FIG. 7B is a graph that shows the theoretical and experimental results of permeation flux through a bottom channel of a microfluidic device for different pressures.

FIG. 8A is a graph that shows the simulation results for fluid streamline and particle trajectories starting at different initial heights in a microfluidic channel with a non-porous surface.

FIG. 8B is a graph that shows the simulation results for fluid streamline and particle trajectories at different initial heights in a microfluidic channel with a porous surface.

FIG. 9 is a graph that shows an experimentally determined percentage of cells that are convected toward a membrane surface versus a percentage of permeation flux through the membrane surface for different pore sizes.

FIG. 10A is a graph that shows experimental particle streamlines optically tracked in a microfluidic device with a non-porous membrane surface.

FIG. 10B is a graph that shows experimental particle streamlines optically tracked in a microfluidic device with a porous membrane surface.

FIG. 11 is a graph that shows experimental cell surface velocities (symbols) and theoretical surface velocities (lines) near a membrane surface.

FIG. 12A is a state diagram showing steady state critical distance at which a number of cells biased towards a porous membrane surface reach maximum packing density for a permeation flux of 10%.

FIG. 12B is a state diagram showing steady state critical distance at which a number of cells biased towards a porous membrane surface reach maximum packing density for a permeation flux of 70%.

FIG. 13 is a graph of cell capture efficiency for prostate cancer cells (PC3) in buffy coat at 70% permeation versus inlet flow rate.

FIG. 14 is a graph of cell capture efficiency for biotinylated polymer beads in buffy coat versus inlet flow rate.

FIG. 15 is a graph showing cake formation kinetics at the highest cell concentration (2.5 M/mL) for porous and discontinuous porous surfaces.

FIG. 16 is a graph showing capture efficiencies for cancer cell lines spiked in undiluted buffy coat.

### DETAILED DESCRIPTION

The present disclosure describes microfluidic devices that contain one or more porous and antibody-functionalized surfaces, e.g., membranes, through which a portion of a particle-containing fluid flows. A porous surface or membrane has at least a portion or section that is porous. For example, all of the surface or membrane can be porous. Alternatively, the surface or membrane can be partly porous and partly non-porous, e.g., a discontinuously permeable porous membrane. The pores enable increased mass transport of particles toward the surface and enhanced surface interactions such that particles can be captured with high efficiency, selectivity, and throughput. The effectiveness of the microfluidic devices described herein arises from enhanced mass transport to and through the porous surfaces and from dynamic rolling adhesion of particles to the functionalized surfaces. These cooperative mechanisms enable excellent performance even at extremely fast flow rates where no capture occurs on conventional solid surfaces.

In addition, the present disclosure describes high-throughput processing that overcomes interfacial limitations such as transport, reaction, and non-specific fouling. To achieve such processing, the functionalized surfaces, e.g., antibody-functionalized surfaces, can have discontinuous permeability, which enables efficient target particle, e.g., cell, capture at high flow rates by suppressing fouling. Edge effects (described below) diminish local shear and promote excess surface accumulation of particles, e.g., cells (referred to herein as “cake formation” or simply as “caking”). By compensating for the edge effects, the microfluidic devices described herein can be operated at higher particle concentrations with significantly improved throughput.

The present disclosure describes the micro fluidic device structures, operation, fabrication, applications, and examples of using the various microfluidic devices.

### Microfluidic Device Structures and Methods of Fabrication

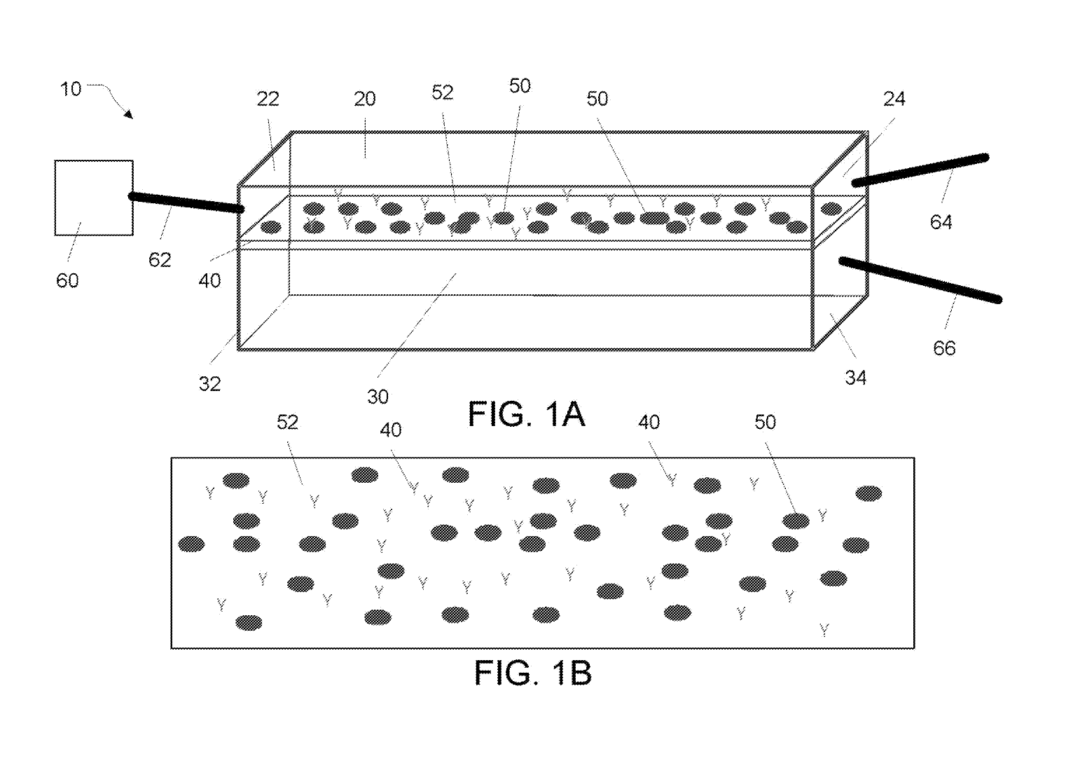

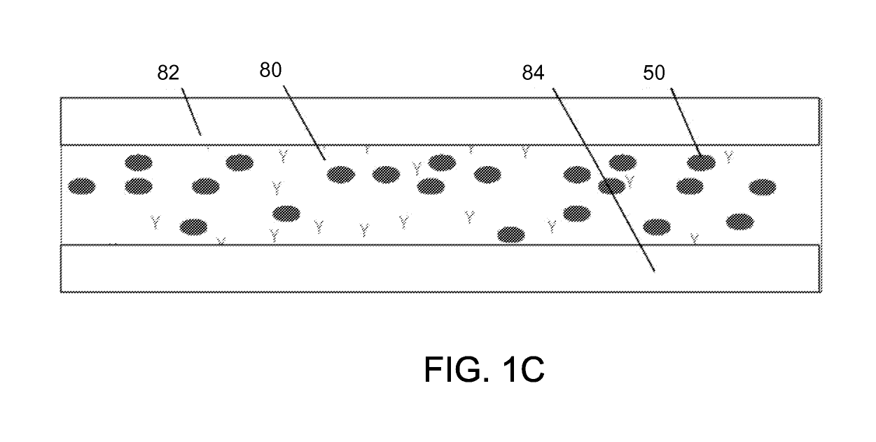

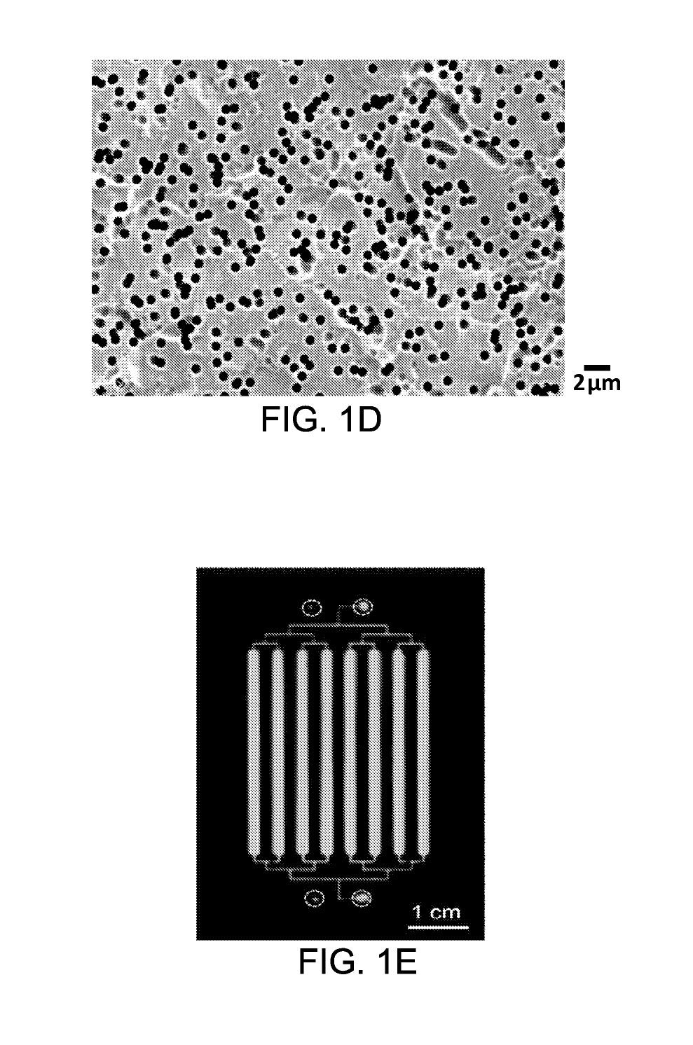

FIG. 1A is a perspective view of an exemplary microfluidic device 10. FIG. 1B is a schematic that illustrates a top view of the microfluidic device 10. A Cartesian coordinate system is shown in both FIGS. 1A and 1B for reference. The device 10 includes a first fluid channel 20 extending alongside a second adjacent fluid channel 30. As shown in FIG. 1A, each of the channels includes an inlet port and outlet port through which fluid can flow. For example, the first fluid channel 20 includes an inlet port 22 on a first end of the device 10 and an outlet port 24 at a second opposite end of the device 10. Similarly, the second fluid channel 30 includes an inlet port 32 at the first end of the device 10 and an outlet port 34 at the second opposite end of the device 10.

As shown in FIGS. 1A and 1B, the first fluid channel 20 is aligned substantially in parallel with the second fluid channel 30. Each channel has a length along the x-direction that ranges from about 0.25 cm to about 10 cm (e.g., about 0.5, 0.75, 1, 2, 3, 4, 5, 6, or 8 cm long), a width along the y-direction that ranges from about 0.1 mm to about 5 mm (e.g., about 0.2, 0.4, 0.6, 0.8, 1, 1.5, 2, 3, or 4 mm), and a height along the z-direction that ranges from about 25 μm to about 500 μm (e.g., about 50, 75, 100, 125, 150, 175, 200, 250, 300, or 400 μm). Preferably, the channel walls are formed from a transparent solid to allow observation of fluid and particle flow. For example, the walls can be formed from glass, polydimethylsiloxane (PDMS), or other suitable microfluidic device material. In some implementations, the width of the channels can increase, decrease or otherwise vary along the length of the device. For example, the width of the first and/or second channel can increase from about 0.1 mm to about 5 mm.

In some implementations, the inlet port 22 is coupled to a pumping device 60, which is used to pump a sample fluid into the first fluid channel 30. Examples of pumping devices include commercially available pumps that inject the sample into the device at a constant pressure or constant flow rate, which can be independently set. The pumping device 60 is coupled to the inlet port 22 through a fluidic coupling component 62 (e.g., a tube). Each of the outlet ports 24, 34 are also coupled to fluidic coupling components 64, 66, at a lower pressure with respect to the inlet of the channel. The pressure differential between the inlet and the outlet ports 22, 34 allows the fluid to flow from the inlet to the outlet. The coupling components can include tubing having an adjustable fluidic resistance. For example, in some implementations, a clamp can be attached to the tubing, at either an inlet port or an outlet port, such that the size of the tube opening can be increased or decreased based on the amount of pressure applied by the clamp. When greater pressure is applied, the size of the opening is reduced, leading to an increase in fluidic resistance and decreased fluid flow through the tubing. In contrast, when the clamp pressure is reduced, the opening increases in size, allowing greater flux of fluid through the tubing. The same effects occur by closing off more or less of the overall area of the outlet.

A porous membrane 40 is positioned between the first fluid channel 20 and second fluid channel 40. The membrane 40 extends along the x- and y-directions, thus separating the first channel 20 from the second channel 30. In some implementations, the membrane 40 is fixed to the walls of the first and second fluid channels using any suitable adhesive or bonding agent (e.g., PDMS) that is capable of ensuring a secure fluid seal and preventing leaking through the device walls and/or delamination of the membrane 40 from the channels. The membrane 40 is formed of a flexible material (e.g., an elastic material that readily deforms in response to force such as cured PDMS or rubber) or rigid material (e.g., a stiff material that resists bending such as polycarbonate or glass) and includes multiple pores 50, which extend from the first fluid channel 20 through the membrane 40 to the second fluid channel 30. The pores 50 are approximately cylindrically shaped openings through which fluid or particles, depending on size, may pass. The pores 50 have a depth or length that is equivalent to the thickness of the membrane 40 (e.g., about 0.5, 1, 2, 4, 6, 8 10, 15, 20, 25, or 50 μm thick) and an average pore diameter that can range from about 10 nm to about 10 μm (e.g., about 0.05, 0.1, 0.25, 0.5, 0.75, 1, 2, or 5 μm). The average pore size can be fixed or can vary across the membrane. In some implementations, the pore sizes are designed to be large enough to allow fluid to pass through from the first fluid channel 20 to the second fluid channel 30, but small enough that any particles (e.g., cells) in a fluid are too large to fit through the pores 50.

In some implementations, the porous membrane 40 can be formed to have discontinuous permeability (FIG. 1C). In a discontinuous permeable surface, a porous permeable surface 80 can be bound by two solid surfaces (a first solid surface 82, and a second solid surface 84). In other words, one section of the surface of the porous membrane 40 can be solid and another section of the surface of the porous membrane 40 can be entirely permeable. For example, near the edges of the porous membrane 40, the surfaces can be solid for a region of about 300 μm (e.g., 50, 100, 150, 200, 250, 300, 350, 400, 450, or 500 μm) from each edge. Near the center of the permeable membrane 40, the surface can be fully permeable. In such a discontinuously permeable porous membrane, the shear would be reduced by 20% rather than by 80% for an entirely permeable surface. In some implementations, the discontinuities can be random, i.e., continuously changing over an area. In some implementations, multiple sections of the porous membrane, for example, multiple sections near the edges, can be without pores, while other sections away from the edges can be with pores.

A scanning electron microscope (SEM) image of the porous surface with pore size radius of approximately 100 nm (GE Healthcare) is shown in FIG. 1D. The pores on the surface allow fluid to permeate through it, but not large particulates such as cells.

The pores 50 can be arranged in random or structured arrays on the membrane 40 (on the surface 80, in FIG. 1C). For example, in some implementations, the pores 50 can be arranged to have decreasing or increasing average pore diameter from an inlet side of the device to an outlet side of the device. The membrane 40 can have an average porosity of membrane surface that ranges from about 2 to about 30 pores/μm². In some implementations, the density of pores on the membrane can be the same across the length or width of the membrane or the density of pores can vary. For example, the density of pores can increase or decrease from the inlet to the outlet of the microfluidic device. The density of pores on the surface can be calculated by looking at scanning electron microscope (SEM) images of the membranes.

In some implementations, the surface 52 of the membrane that is exposed to the first fluid channel 20 is functionalized with binding moieties 70 that can be used to capture or adhere to particles (e.g., cells) flowing through the channel 20. The binding moieties 70 are covalently or non-covalently bound to the surface 52 through functional groups (e.g., —NH₂, —COOH, —HS, —CnH2ₙ₋₂). In general, a binding moiety is a molecule, synthetic or natural, that specifically binds or otherwise links to, e.g., covalently or non-covalently binds to or hybridizes with, a target cell, a target molecule, or with another binding moiety (or, in certain embodiments, with an aggregation inducing molecule). For example, the binding moiety can be a synthetic oligonucleotide that hybridizes to a specific complementary nucleic acid target. The binding moiety can also be an antibody directed toward an antigen or a ligand from any protein-protein interaction or liquid-binding pair. Also, the binding moiety can be a polysaccharide that binds to a corresponding target. In certain embodiments, the binding moieties can be designed or selected to serve, when bound to another binding moiety, as substrates for a target molecule such as enzyme in solution. Binding moieties include, for example, oligonucleotide binding moieties, polypeptide binding moieties, antibody binding moieties (e.g., biotinilated anti-EpCAM and antibodies to E-Cadherin, Mycin-1, Epidermal Growths Factor Receptor; examples of other cell surface markers to which antibodies may be bound can be found, e.g., in Table 1 of US 2007/0026469, incorporated herein by reference in its entirety), antibody fragments, nucleic acids, cellular receptors, ligands, aptamers, MHC-peptide monomers or oligomers, biotin, avidin, oligonucleotides, coordination complexes, synthetic polymers, carbohydrates, or polysaccharides.

Although a single first fluid channel is shown in FIG. 1A, the device also can include multiple separate first fluid channels. For example, multiple first fluid channels (e.g., 2, 4, 8, or 16 channels) can be arranged in parallel between the inlet and outlet ports to increase the flow throughput of the microfluidic device. Similarly, the microfluidic device can include, for example, multiple second fluid channels (e.g., 2, 4, 8, or 16 channels) arranged in parallel. In some implementations, multiple first and second channel pairs, each including a fully or partially porous membrane, e.g., a discontinuously permeable porous membrane, between them, can be coupled in a multiplexed channel architecture. For example, the multiplexed channel architecture can include eight or more parallel channel pairs (FIG. 1E).

### Micro Fluidic Device Operation

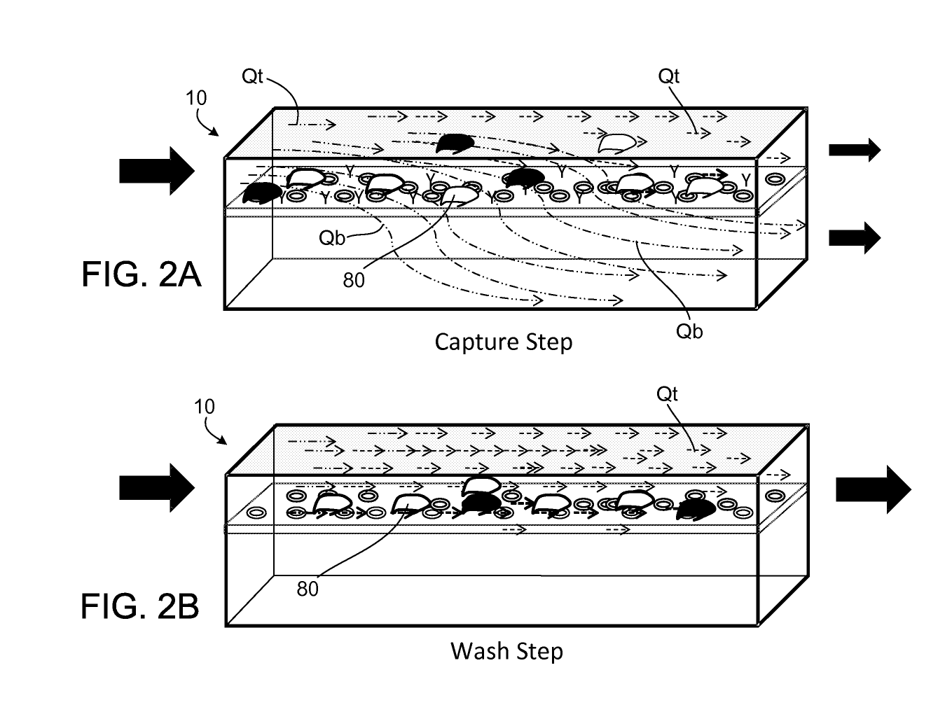

The operation of the device microfluidic device 10 is separated out into two phases: a particle capture phase and a washing phase. FIG. 2A is a schematic of an example of a microfluidic device 10 during the particle capture phase. FIG. 2B is a schematic of an example of a microfluidic device during the washing phase. In the particle capture phase, the sample fluid is introduced into the first fluid channel 20 through the inlet port 22 using a pumping device (not shown). The inlet pressure at the first fluid channel 20 can be set using the pumping device relative to atmospheric pressure. In some implementations, the outlet ports 24, 34 are both left at atmospheric pressure. The sample fluid can include any particles 80 of interest that are intended to bind to the binding moieties 70 on surface 52 of the membrane 40. For example, the sample fluid can include biological macromolecules such as cells (mammalian cells, blood cells, e.g., white blood cells such as monocytes, basophils and neutrophils, and red blood cells, cancer cells, e.g. circulating tumor cells (CTC) and fetal cells in maternal blood), molecules (e.g., nucleic acid, proteins, bacteria, viruses, cells, cancer markers), or other biological or non-biological particles (antibody or protein functionalized beads) that specifically bind to the binding moieties on the membrane surface 52. In some implementations, the sample fluid also can include particles that do not specifically bind to the binding moieties on the membrane surface.

During this initial capture phase, the inlet port 32 to the second fluid channel 30 is closed. For example, in some implementations, a tube coupled to the inlet port 32 is clamped so that the tube opening is entirely or almost entirely blocked and little or no fluid flows into or out of port 32. In some implementations, the inlet port 32 is opened in order to flush out bubbles in the bottom channel should bubbles enter the bottom channel of the microfluidic device. At the same time, the outlet port 24 of the first fluid channel 20 and the outlet port 34 of the second fluid channel 30 are left open (e.g., tubes connected to those channels are not clamped). As a result, a portion of sample fluid flows through the first fluid channel 20 to outlet port 24 whereas another portion of the sample fluid flows through the porous membrane 40 to the outlet port 34.

The flux of fluid through the channel 20 can be depicted as including two components: (a) fluid flux, Qt, from the inlet port 22 to the outlet port 24 of the top channel 20 and (b) a fluid flux, Qb, through the porous membrane 40 into the bottom channel 30. The bulk flow of the sample fluid in the first fluid channel 20 is in the direction of Qt (i.e., tangential to the membrane surface) and decreases along the length of the channel 20 as a result of the pressure drop between the inlet port 22 and the outlet port 24. There is also a pressure drop across the membrane due to the open outlet port 34 being at a lower pressure (e.g., atmospheric pressure) than the inlet port 22. Thus, during the capture phase, particles in the fluid sample will experience convective transport to the surface of the membrane 40. The convective transport is induced by the fluid flux Qb of the fluid sample toward the membrane 40 and through the pores. Upon reaching the membrane 40, at least some particles begin to roll or progress along the membrane surface in a direction towards the outlet port 24. This particle movement along the surface is induced by the fluid flux Qt through the first channel 20.

At the same time, the velocity of particles along the surface is constrained by the transverse flux Qb of fluid through the porous membrane, i.e., the flow of the sample fluid through the pores creates a suction force near the boundary layer of the membrane. As a result, the particles experience a deceleration and reduced shear stress along the length of the surface of the porous membrane. The motion of the particles near the membrane surface slows and the particles are then capable of attaching to the binding moieties to complete the particle capture phase. In particular, the particles experience (a) an increase in the particle-antibody bearing surface interaction, (b) an increase in the particle-surface encounter duration due to intermittent stop-and-go motion of the particles on the surface, and (c) a reduction in shear stress experienced by the particles on the membrane surface along the length of the channel, resulting in increased specific binding of particles.

Each of the foregoing enhancements related to particle capture at the membrane surface can be achieved using high flow rates that would otherwise inhibit the binding of particles to the membrane surface. Therefore, the enhanced capture efficiency of particles at high volumetric flow rates allows one to process large volumes of sample in a short time. The parameters that affect whether a particle will bind to a binding moiety during the capture phase can depend on several factors including, for example, the sample fluid flow rate, the height of the first fluid channel, the length of the first fluid channel and/or the density of binding moieties on the membrane surface. For example, for a specified channel dimension the target cell efficiency decreases with the increase in sample flow rate. In an example device, an increase in flow rate from 1.5 ml/hour to 6 ml/hour reduces the capture efficiency from about 78% to about 65%).

The amount of transverse flux Qb through the membrane relative to the flux Qt can be adjusted by changing the size of the outlet ports in the first and second fluid channels. For example, Qb can be enhanced or reduced relative to flux Qt by increasing or decreasing the size of the opening at the outlet port 34 (e.g., changing the clamping pressure on a tube connected to outlet port 34) so that flow is restricted through the outlet 34. Alternatively, or in addition, the size of the opening at outlet port 24 can also be adjusted (e.g., by increasing or decreasing clamping pressure on a tube coupled to the outlet port 24).

Furthermore, the discontinuous nanoporous capture surfaces can be engineered to suppress non-specific caking of cells in the devices even at high cell concentrations, enabling a further increase in throughput. Caking initiated at the channel edges was observed to grow inward over time, perhaps due to a substantial reduction in the local shear near the channel walls due to “edge effects,” which prevented accumulated cells from being cleared. By rendering the capture surface impermeable near the edges, it was possible to overcome the edge effects and increase the shear above a critical threshold to prevent caking of the cells.

Once the particle capture phase is completed, the washing phase commences. During the washing phase, the second fluid channel inlet port 32 and outlet port 34 are closed. For example, tubing coupled to both the inlet and outlet ports 32, 34 are clamped such that little or no fluid can enter or exit the ports 32, 34. In contrast, the inlet port 22 and outlet port 24 of the first fluid channel 20 remain open. Using a constant flow pump, a rinsing solution (e.g., distilled water, phosphate buffer saline and paraformaldehyde such as phosphate buffered saline then is pumped into the first fluid channel 20 through the inlet port 22. The rinsing solution flows through the first fluid channel 20 towards the outlet port 24, which is maintained at a lower pressure (e.g., atmospheric pressure) than the inlet and is flushed out the port 24. Because the ports in the second fluid channel 30 are closed, there is little or no boundary suction through the pores of the membrane such that the fluid flux Qt is primarily the dominant component of fluid flow and Qb is substantially reduced to zero or close to zero. The rinsing solution washes away particles in the fluid channel that do not specifically bind to the binding moieties.

The process of particle rolling and binding is intended to mimic vasculature morphology as seen during hematopoietic stem cell homing, leukocyte homing during inflammatory response and cancer cell metastasis. Even though all these processes have different functions in physiology and pathology, the underlying morphologies of the vessels in which the different cell types perform their functions have a common porous architecture, which establishes different flow fields around the porous surfaces. The different flow fields, both parallel to and towards the porous surface allow for enhanced cell capture at high flow rates by decreasing the shear forces experience by cells near the surface. Similarly, the micro fluidic device 10 is configured to have a similar physiological vasculature that produces the transverse flow fields when a sample fluid is pumped through the first fluid channel 20 during the particle capture phase.

In some implementations, the sample fluid contains more than one type of particle. For example, the sample fluid may contain a first particle that specifically binds to the binding moieties of the membrane surface and a second particle that does not specifically bind to the binding moieties. In some cases, the second particles will be washed away through outlet port 24 during a wash step. Alternatively, if the second particles are small enough to pass through the pores of the membrane 40, a portion of the second particles may be washed out through the membrane 40 and into the outlet port 34 of the second fluid channel 30. In some implementations, the membrane 40 may include a second type of binding moiety that specifically binds to the second particle and not to the first particle. Thus, both the first and second particles will bind to the membrane surface during the particle capture step.

Micro fluidic Device Fabrication

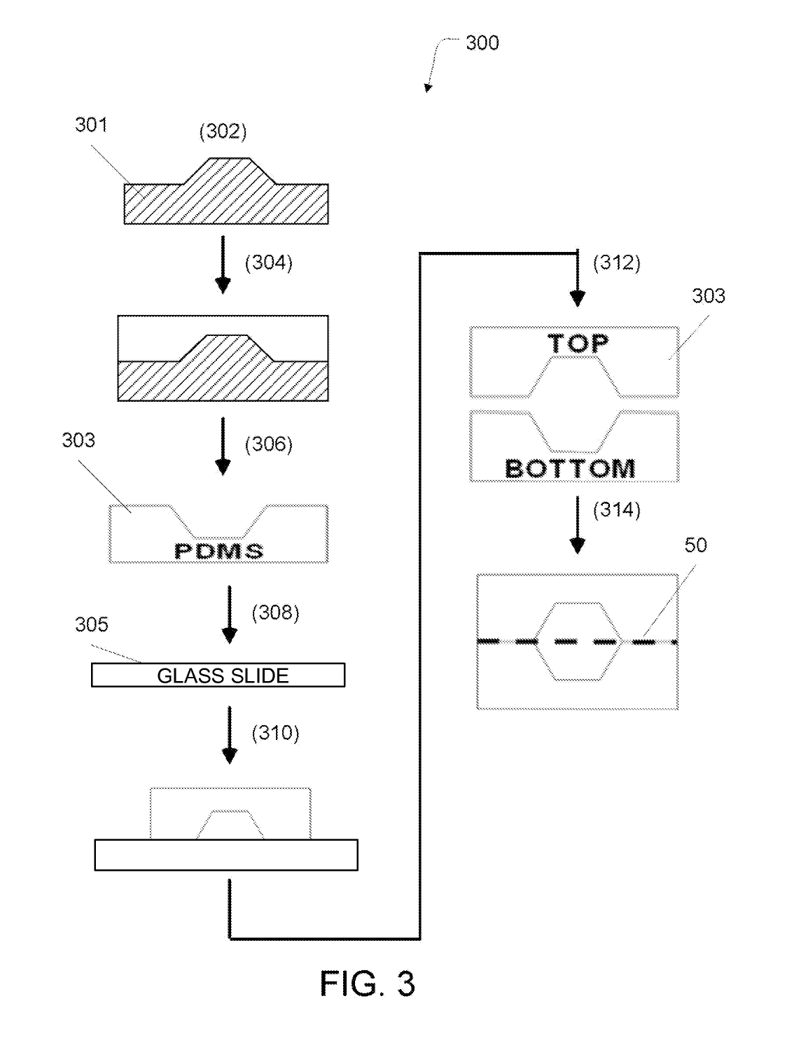

A method 300 of fabricating the microfluidic device 10 is shown in FIG. 3, though other methods of manufacture can be used. In a first step, molds 301 of the first and second fluid channels are obtained (302). For example, the molds can be formed of a polymer (e.g., SU8) and can be fabricated using standard photolithographic procedures. In some implementations, the top and bottom fluid channel shapes are identical so only a single mold is necessary. In other implementations, the first and second fluid channels may have different configurations (e.g., different height, width, and/or length) so two molds would be used. For example, in some implementations, the second fluid channel is taller compared to the first fluid channel to allow fluid permeation through the membrane. Once the molds are obtained, a solution of liquid or material, such as a plastic, e.g., uncured polydimethylsiloxane (PDMS), is dispensed over the molds (304). The solutions are cured (e.g., by adding a curing agent and heating at about 65° C.) and the cured PDMS channels 303 are removed from the molds (306) to form the top and bottom halves of the microfluidic device 10.

A thin layer 305 of uncured PDMS diluted in toluene (e.g., 50% v/v) is then spun onto a glass slide using a high-speed spinner (308) and stamped by the two PDMS halves (310). As a result, a thin layer of liquid PDMS is transferred onto the solid PDMS surfaces. The PDMS halves 303 are aligned and the membrane 40 (e.g., commercially available 10 μm thick polycarbonate available from GE Healthcare) then is integrated between them (312). In particular, the membrane is gently placed over one of the two PDMS halves whereas the other PDMS half is carefully aligned over the membrane. The membrane 40 is then sandwiched by gently pressing the PDMS halves 303 against the membrane (314). The device 10 as constructed then is allowed to sit at room temperature for several hours (e.g., over-night) until the PDMS solution on the surfaces of the first and second (e.g., top and bottom) fluid channels is cured and forms a seal against the membrane. In some implementations, the pores in the membrane are fabricated using dry etching techniques (e.g., reactive ion etching) or wet chemical etching techniques (e.g., KOH etching) where the membrane is covered with a patterned coating (e.g., photoresist) to protect regions that are not to be etched.

After the membrane is sandwiched between the PDMS halves, the membrane can then be functionalized with binding moieties. In some implementations, the functionalization process can include several incubation steps. For example, to functionalize the surface with an antibody (e.g., anti-EpCAM), the first fluid channel 20 of the microfluidic device 10 can be incubated (e.g., about 12 hours) with a solution of glutaraldehyde to immobilize the protein binding moiety to the polycarbonate membrane. The device 10 is washed with a buffer solution (e.g., phosphate buffer) to remove the glutaraldehyde and then incubated with Avidin (e.g., about 20 μg/ml) for about 2 hours at room temperature. The device 10 then is washed again with a buffer solution and the first fluid channel of the device is incubated with the antibody solution (e.g., biotinilated anti-EpCAM at a concentration of about 30 μg/mL). Finally, the fluid channel is washed again with phosphate buffer and incubated with a surfactant (e.g., 5% Pluronic F108 in 2 bovine serum albumin) to reduce non-specific binding of particles on the membrane surface.

### Applications

The microfluidic devices described herein can be used for isolating specific particles from fluid samples at high flow rates. The decrease in shear stress experienced by particles at the membrane surface during the particle capture phase enables an increase in specific particle capture for a particular flow rate and thus an increase in device throughput. In some implementations, the devices described herein can be used as biological target separation and/or sorting devices for identification and analysis of biological targets. In certain implementations, the devices described herein can be used as part of point-of-care diagnostic and pathology systems.

As noted above, a fluid sample may include a liquid containing a number of particles that are designed to specifically bind to the binding moieties on the membrane surface. Target particles can include a variety of target biomolecules (e.g., proteins, bacteria, viruses, cells, cancer markers). The devices can be used to isolate and analyze populations of cells (e.g., mammalian cells, blood cells, e.g., white blood cells such as monocytes, basophils and neutrophils, and red blood cells, cancer cells, e.g., circulating tumor cells (CTC) and fetal cells in maternal blood) from fluid samples. Fluid samples can include, for example, turbid samples such as blood, blood sample derivatives (e.g., buffy coat), sputum, urine, or samples that have been prepared using techniques including, but not limited to, filtering or centrifugation.

### EXAMPLES

The invention is further described in the following examples, which do not limit the scope of the invention described in the claims.

### Device Fabrication

The devices used in Examples 1 to 5 described below were fabricated as follows. A 10:1 solution of PDMS and curing agent was applied to a SU-8 mold of the fluidic channels and cured to form a first half of the microfluidic device, where the first half contained a groove corresponding to the first channel. The process was repeated to form the second half of the microfluidic device in which the second half contained a groove corresponding to the second channel. A thin layer of uncured PDMS diluted in toluene (50% v/v) was spun onto a glass slide using a high-speed spinner. Each cured PDMS half then was stamped in the uncured PDMS. A thin layer of the uncured PDMS was transferred onto the respective surfaces of the PDMS halves. A polycarbonate membrane approximately 10 μm thick (GE Healthcare) was placed between the two halves and the halves were gently pressed against the membrane. Membranes having pore radius of 0.1 μm and 0.6 μm were used. For membranes with 0.1 μm pore radius, the total number of pores was about 10¹¹. For membranes with 0.6 μm radius, the total number of pores was about 2.7×10⁹. A third device containing a non-porous membrane also was used as a control device for comparison against the devices containing a porous membrane. The constructed devices were allowed to sit at room temperature over-night until the thin layers of PDMS were cured. The channel lengths were about 4 cm. The channel heights were about 100 μm. The channel widths were about 2 mm. The device was capable of handling pressures up to 7.5 Psig before breaking.

### Sample and Device Preparation

For the examples described below, samples were prepared in the following manner. Prostate cancer cells (PC3) were fluorescently labeled with Cell tracker Orange stain in DMSO and the buffy coat was separately labeled with Calcein green stain in DMSO. Excess fluorescent stains were removed from each sample by centrifugation and the cells were re-suspended in cell media. The cancer cells were spiked into the buffy coat sample at a concentration of 2000 cells/mL and the samples were loaded into a 60 mL syringe under rocking motion to preclude cell settling.

The device was covalently functionalized with EpCAM antibody before introducing the sample. First, the microfluidic channels were incubated with glutaraldehyde. After incubation of the microfluidic channel, the device was thoroughly washed with phosphate buffer and incubated with about 20 μg/mL of Avidin in Phosphate Buffer Saline. The device was then washed with buffer again and the top channel of the device was then incubated with Biotinilated Anti-EpCAM in 2% Bovine Serum Albumin for about 2 hours. The antibody was washed with phosphate buffer and the device was incubated with 5% Pluronic F108 in 2% bovine serum albumin in order to reduce non-specific binding of cells. A similar functionalizing protocol was used to cover the surface with Biotinilated IgG instead of Biotinilated EpCAM, by incubating the device with Biotinilated IgG after Glutaraldehyde incubation.

### Device Operation

The samples used in the experiments (PC3 cancer cells in Buffy coat) were introduced through the inlet of the top channel using a constant pressure pump. The inlet pressure in the top channel was set at a using the constant pressure pump relative to the atmospheric pressure at the top and bottom outlets. Waste was collected at the outlets using a 6 well plate.

The operation of the device was separated into two phases. The capture phase and the washing phase. In the capture phase, the sample was introduced into the top channel through the top inlet. The splitting of the flow was based on balancing the resistances and outflow through the outlet tubings in both the top and bottom channel. The bottom inlet was clamped during the capture phase. In the washing phase, the tubes coupled to the bottom channel inlet and outlet were clamped and rinsing buffer was flowed in the top channel using a constant flow pump in order to wash away non-specific binding.

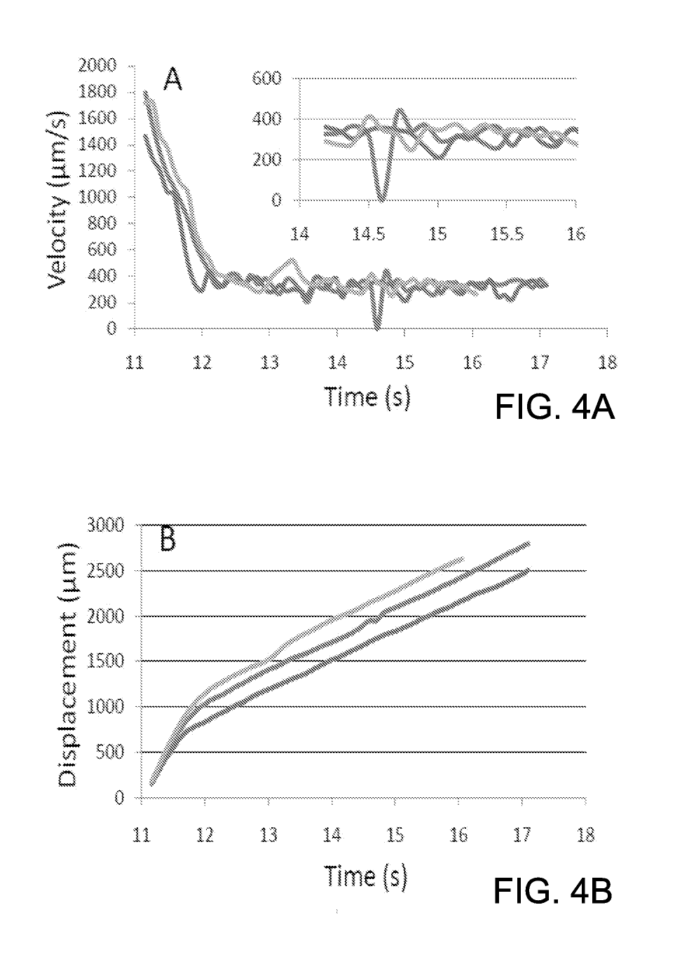

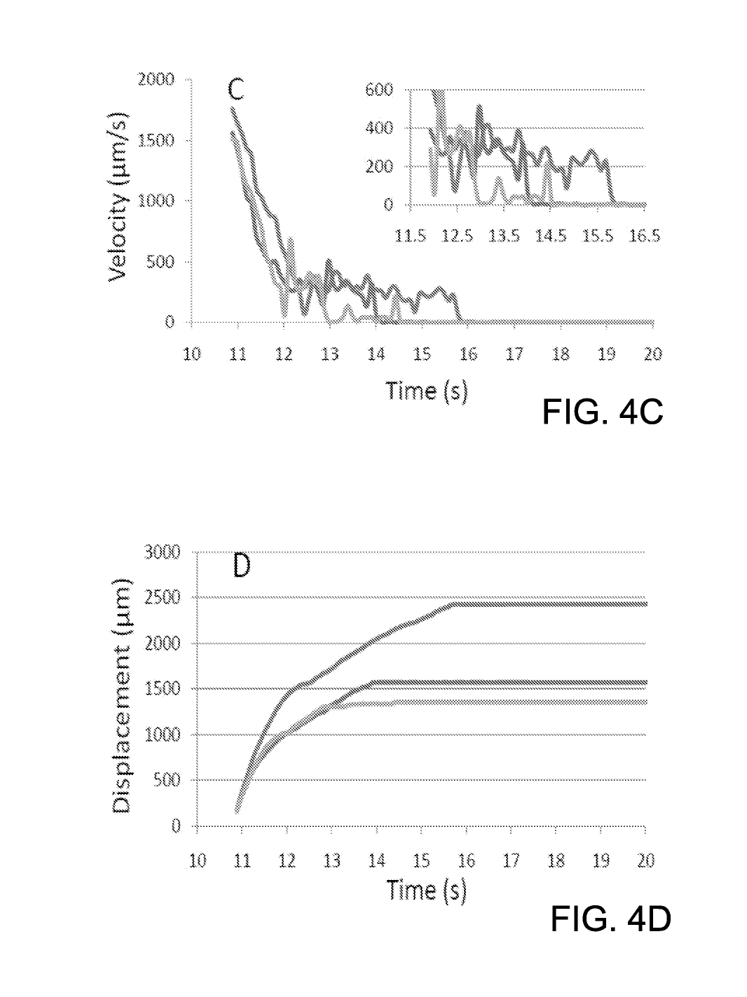

Videos were recorded using 4× and 10× objectives of a Nikon 90i microscope. For each condition of fluid split more than 30 cells were tracked over a field of view of 3 mm (at 4×) and at different positions along the length of the channel using commercial software (NIS elements). The software provided velocities and displacement characteristics of each tracked particle (see FIGS. 4A-4D). The average velocity for each condition was reported as the mean and standard deviations.

The device was imaged under an automated upright fluorescence microscope (Eclipse 90i, Nikon, Melville, N.Y.) using a 10× objective focused on the surface of the porous surface. Three different emission spectra (DAPI, Cell Tracker Orange, and FITC) were used to differentiate the target spiked cells from the surrounding buffy coat.

The capture efficiency of the spiked PC3 cancer cells for each condition was calculated by counting the number of spiked cells captured in the device divided by the total number of cells flowed through the device (i.e., the number of cells captured plus the number of cells in a 6 well waste collection). Each condition was repeated three times and the statistics of the results were reported in mean and standard deviations. The PC3 cell spike count was checked before spiking into the buffy coat sample as well as right before loading the sample into the syringe pump. The captured spiked cells on the device were counted by using Cell Tracker Orange (CTO) filter on the microscope.

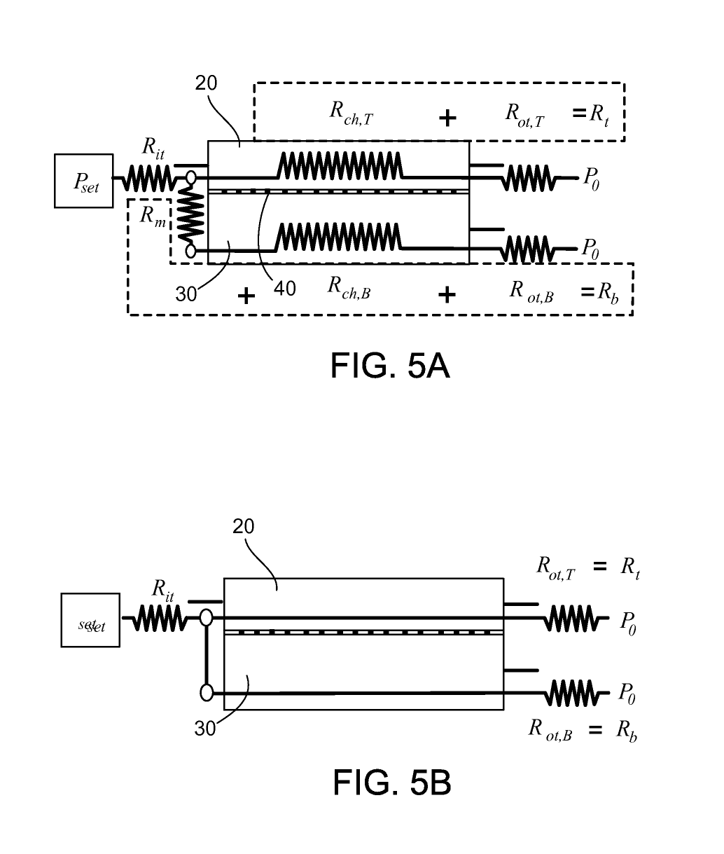

Since the optimal working of the device depended on the fluid flux through the top channel and the membrane, the same fluid field conditions were reproduced in order to compare different devices. We achieved this using a lumped resister model shown in FIG. 5A and FIG. 5B, where the component resistances of the devices are shown. The fluidic resistances of these components are shown in Table 1.

The channel resistances were calculated using eqn. S.1

$${R}_{ch} = \frac{12 μ {L}_{ch}}{{wh}^{3}} , \qquad ( S .1 )$$

where L_{ch} is the channel length in cm, w is the channel width in mm, h is the channel height in μm (which may vary depending on whether the top or bottom channel is selected), and μ is the viscosity of the fluid flowing through the device. The tubing resistances were calculated using eqn. S.2

$${R}_{tubing} = \frac{8 μ {L}_{t}}{π {r}_{t}^{4}} , \qquad ( S .2 )$$

where Lₜ is the tubing length and rₜ is the radius of the tube opening. The membrane resistances were calculated using equation S.3

$${R}_{m} = \frac{8 μ {L}_{p}}{π {r}_{p}^{4}} \cdot \frac{1}{n} , \qquad ( S .3 )$$

Where rₚ is the pore radius, Lₚ is the pore length, and n is the number of pores per cell area. Based on the above resistances, the theoretical flow rates in the top channel and membrane were given by

$$\begin{matrix}{Q}_{t} = \frac{{R}_{b} P}{( {R}_{in} ( {R}_{b} + {R}_{t} ) + {R}_{b} {R}_{t} )} ; & ( S .4 ) \\ {Q}_{b} = \frac{{R}_{t} P}{( {R}_{in} ( {R}_{b} + {R}_{t} ) + {R}_{b} {R}_{t} )} ; & ( S .5 )\end{matrix}$$

Where P is the pressure set on the pump,

Rₜ=R_{ch,T}+R_{ot,T}; (S.6)

R_{b}=Rₘ+R_{ch,B}+R_{ot,B}; (S.7)

and if

R_{ot,T}>10*R_{ch,T},R_{ot,B}>10*(R_{ch,B}+R_{ot,B}); (S.8)

Rₜ=R_{ot,T}; (S.9)

R_{b}=R_{ot,B}; (S.10)

TABLE 1
Different fluidic resistance components of the device

| | | | Top | | Bottom | |
|---|---|---|---|---|---|---|
| | Inlet | Top | Outlet | Bottom | outlet | |
| | tubing | Channel | tubing | Channel | tubing | Membrane |
| | Rᵢₜ | R_{ch,T} | R_{ot,T} | R_{ch,B} | R_{ot,B} | Rₘ |
| Fluidic | 9.7 × | 2.4 × | 1.9 × | 1.5 × | Fraction | rₚ = 0.1 μm |
| Resistance | 10¹² | 10¹¹ | 10¹³ | 10¹⁰ | of the | Rₘ~10¹¹ |
| | | | | | top | rₚ = 0.6 μm |
| | | | | | outlet | Rₘ~2.7 × |
| | | | | | tubing | 10⁹ |

As indicated in Table 1, the bottom outlet tubing resistance was set to control the fluid flux split between the top channel and the porous membrane.

Using the resistance values in Table 1, the output tubings had resistance much greater (about 10 times) than the fluidic resistance of the channel or the membrane. Under this condition, the resistance model can be simplified from FIG. 5A to FIG. 5B. The effect of the simplified model is to maintain a constant pressure difference along the length of the membrane and, therefore, a constant uniform velocity of fluid flux at the wall. From equation S.4-S.10, we see that the sample fluid flow rate through the top channel and the membrane depended on the absolute values of the top and bottom output tubing resistances, but the split depended on the ratios of the two.

### Example 1

### Calibration and Fluid Permeation Flux Through the Porous Surface

Samples with low input particle cell fraction sample (φ₀≦0.1) were used to calibrate the amount of fluid split through the top (first) and bottom (second) channels. The sample was collected over a span of 10 minutes using large resistance tubing at the outlets of the top and the bottom channel. Various components (channel height, Pressure, Membrane pore size, and output tubing lengths) of the lumped resistance models were systematically changed one at a time in order to ascertain the validity of the lumped resistance model. Measurements on five devices were made for each measurement. The collected fluid was measured using a high sensitivity weight balance over a known period of time.

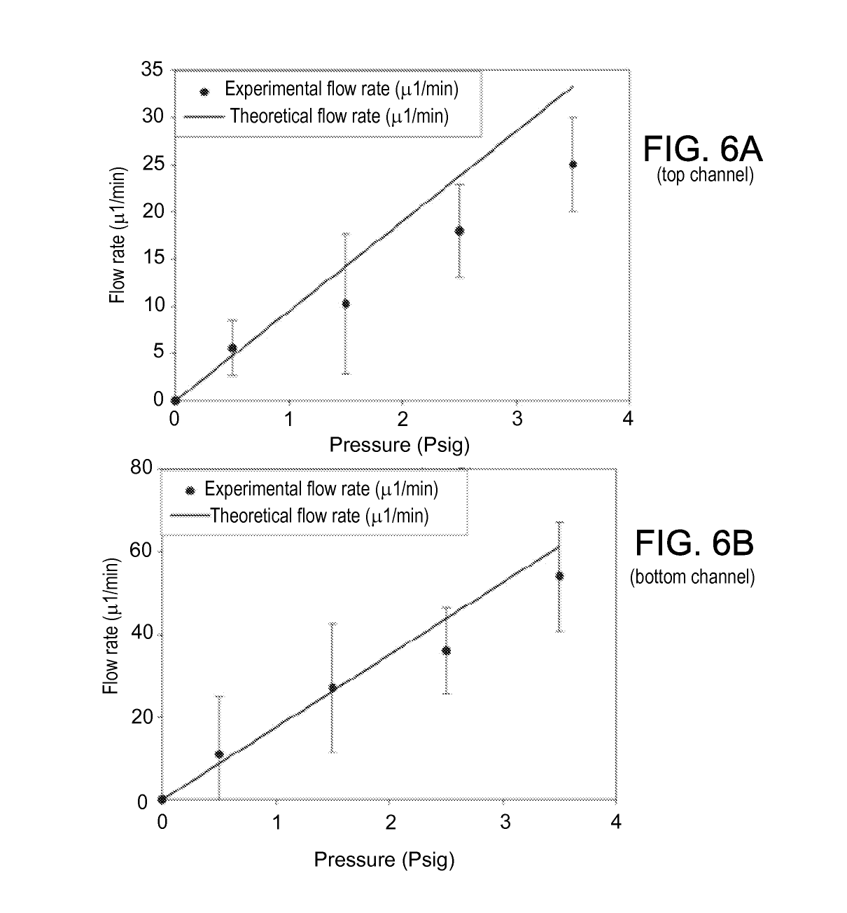

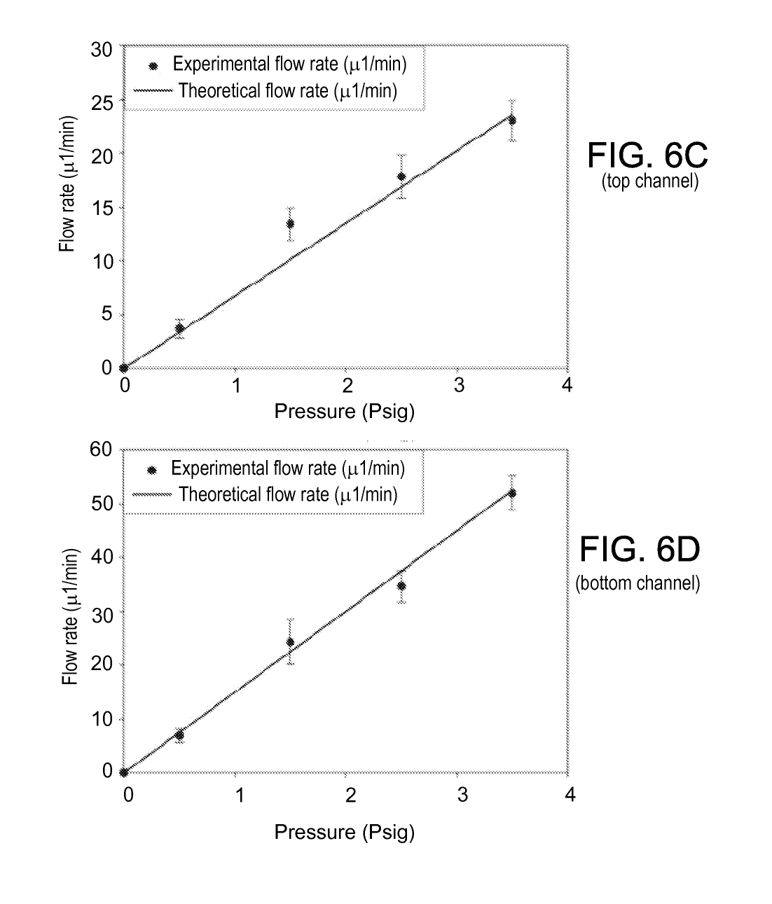

Maintaining a constant permeation flux through the porous surface can be useful for reproducing fluid dynamic conditions inside the device. The parameters influencing percentage permeation fluid flux through the top channel and the porous surface can be lumped into the component resistances of the device. Commercially available porous surface membranes have variable porosities (5%˜14%, GE Healthcare) and in order to get rid of this porosity variance we introduced large resistive tubing at the top and bottom channel outlets. These resistances allowed us to maintain constant permeation velocity at the porous wall and reduce the variation in the permeation flux through the membrane due to variation in the porosity of the commercially manufactured membrane. As a way of calibrating our devices, we measured the flow rates through the top channel and the porous surface as a function of pressure and found that as long as the output tubing resistances were large compared to the membrane and channel resistances (e.g., about 10 times greater), the theoretical values of the flow rates (equation S.4 and equation. S.5) and the experimentally obtained flow rates were in good agreement (see FIG. 6A, 6B).

FIGS. 6A and 6B show experimental flow rates versus theoretical flow rates for the top and bottom channels for output tubing resistances comparable to the theoretical membrane resistance.

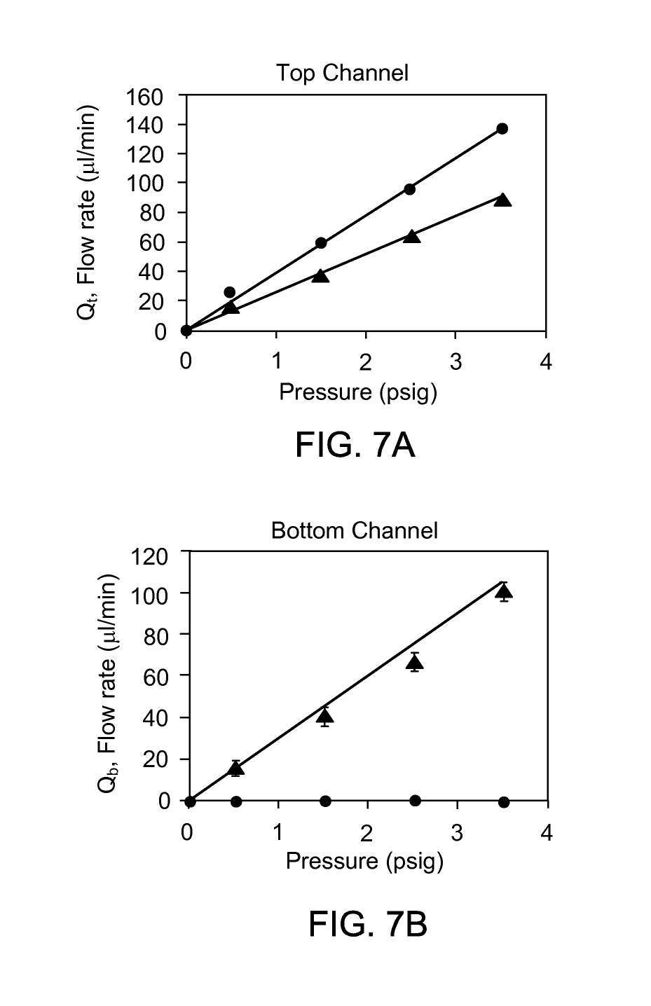

FIGS. 6C and 6D show experimental flow rates versus theoretical flow rates for output tubing resistance that is ten times the average theoretical membrane resistance. In FIGS. 7A and 7B we show the theoretical and experimental results of permeation flux through the top channel and membrane for different pressures (rₚ=100 nm, percentage of total fluid flux that flows through the porous surface, ψ˜0.45). Table 1 above shows the comparative resistance of different elements of the resistance model and the rationale behind simplifying the model. Large resistive tubing allowed us to gain substantial control over fluid split (˜5% variation) and reproduce our results.

### Example 2

### Cell Trajectories

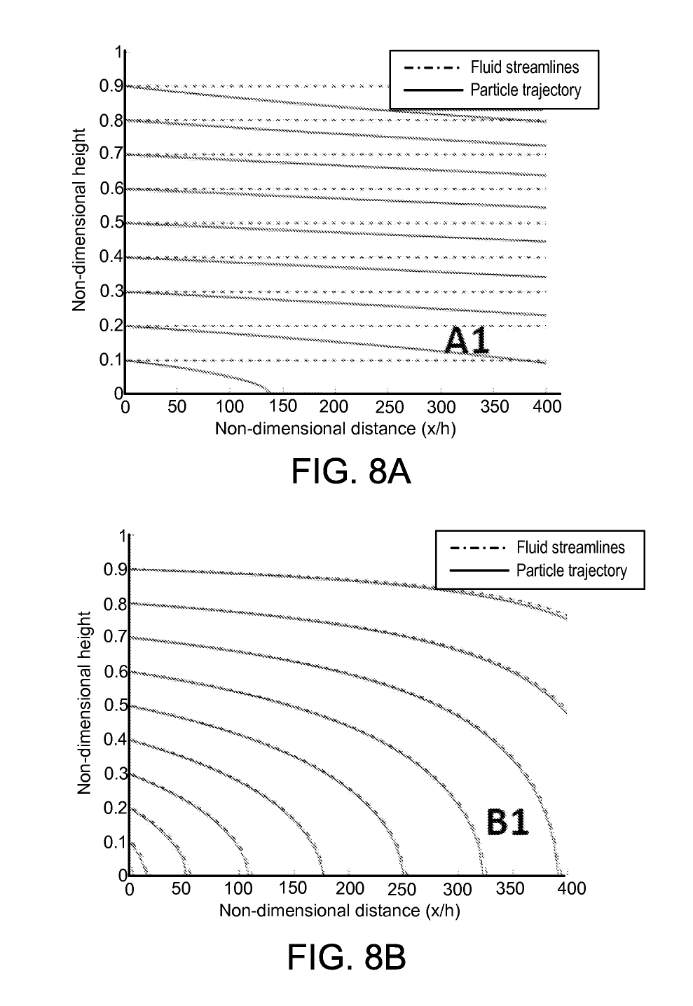

In our experiments the channel height (˜100 μm) was several times larger than the average lumen diameter of capillaries in-vivo (6-10 μm) where the cell rolling, capturing, and extravasation occurs. In capillary lumens of this size, cells (˜10 μm) have to squeeze through, and are in constant contact with the surface. However, at heights on the order of 100 μm, cell interaction with the solid surfaces in a rectangular channel is severely transport limited due to laminar flow and high channel Peclet number (Pe_{ch}<<1). By allowing fluid permeation through the porous surface, we introduced a transverse fluid field in the y-direction and that helped convect cells to the reactive porous membrane surface giving the target cells a chance to attach to the antibody coated surface. Additionally, the axial x-direction fluid field, that shears the cells on the surface, depended on the fluid depleted through the porous membrane in the transverse direction. FIG. 8A is a graph that shows the simulation results for fluid streamline and particle trajectories starting at different initial heights, Yₐ=yₒ/h, in a microfluidic channel of similar dimensions with a non-porous surface. FIG. 8B is a graph that shows the simulation results for fluid streamline and particle trajectories at different initial heights in a microfluidic channel with a porous surface. We see that the particle trajectories deviated very little from the fluid streamline trajectories due to large wall Peclet number (Pe_{w}<<1) and negligible contribution from hydrodynamic and sedimentation effects.

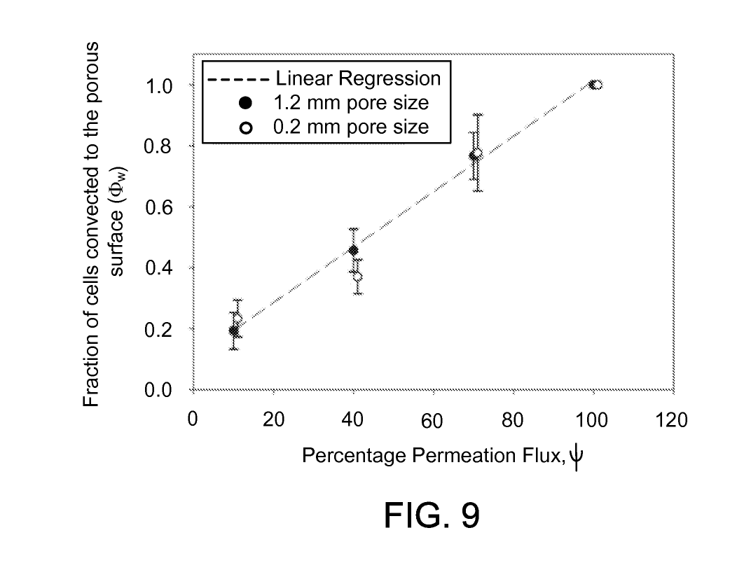

This indicated that the number of cells convected to the porous surface was proportional to the fluid flux through the porous surface, assuming that the particles entering the channel were uniformly distributed across its height. We used different porous surfaces (rₚ˜100 nm and rₚ˜600 nm) to confirm that pore size of the porous surface had no effect on the percentage of particles convected to the surface as long as the total permeation flux through them were the same. FIG. 9 is a graph that shows the experimentally determined percentage of cells that were convected toward the surface versus the percentage of permeation flux through the membrane. The permeation flux was kept constant for different pore size membranes by balancing the outlet tubing resistances in accordance with the lumped parameter model.

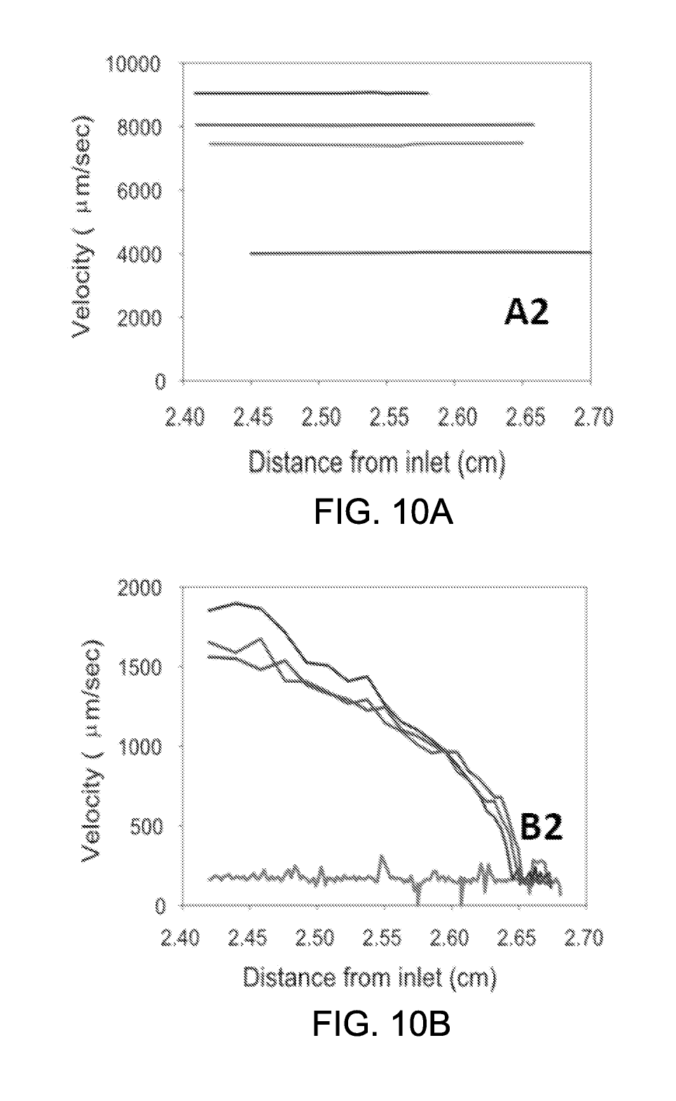

We captured micrographs generated by tracking particles over the field view of 3 mm in channel with a non-porous surface and porous surface at flow rate of 100 μl/min FIG. 10A is a graph that shows experimental particle streamlines optically tracked in a microfluidic device with a non-porous membrane surface. FIG. 10B is a graph that shows experimental particle streamlines optically tracked in a microfluidic device with a porous membrane surface. As seen from these micrographs, particles in the non-porous device micrographs traveled in the bulk at high velocities (˜4000 m/s to 10,000 m/s), whereas for the porous surface device we see particles were convected to the surface, reducing the cell velocity from ˜1700 m/s in the bulk to ˜250 m/s on the surface. Accordingly, the boundary layer suction established by the device was capable of significantly reducing the cell velocity.

### Example 3

### Cell Rolling Velocity on a Porous Surface

Once the cell was on the surface, we found that the cell velocity depended on the shear stress exerted on the cell at the surface. The bulk suspension flow in the channel was tangential to the membrane surface and decreased along the length of the channel due to depletion of fluid in the transverse direction. As long as the shear stress on these cells was larger than the transverse component of the fluid field, the cell moved along the porous surface.

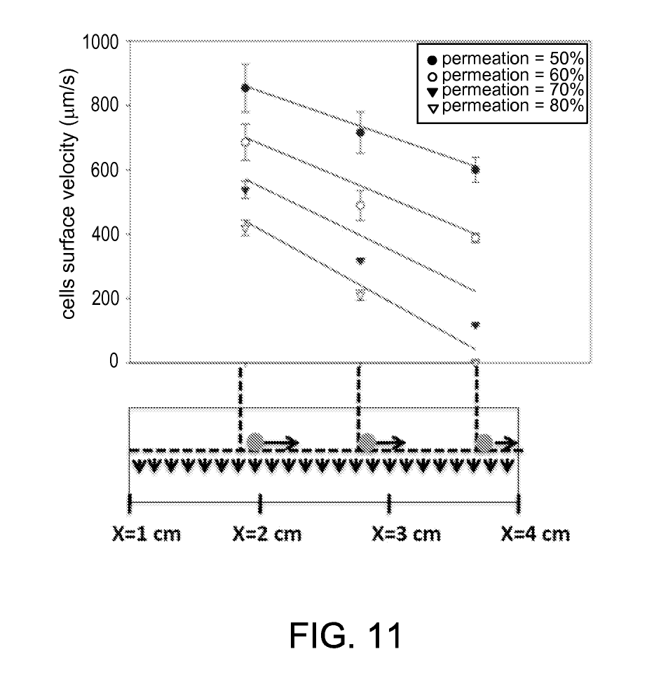

We compared the cell surface velocities (FIG. 11) at a separation distance of 500 Å from the membrane surface in our device with theoretical results where the velocity of a particle rolling close to a surface was measured at the same particle surface separation distance in Table 2 below. We saw that for low permeation flux (˜50%), the experimental cell rolling velocity on a porous surface and theoretical values of a particle at a separation distance off 500 Å from a solid surface were in close agreement. However, as we increased the permeation flux (>60%), the velocities of the cells started to deviate from that predicted by theory. The difference in these velocities at high permeation fluxes was likely because of the increased retardation of the translational motion of the cell due to significant local transverse component of the fluid field around the cell. A theoretical linear fit is shown in FIG. 11 using solid lines.

TABLE 2
Theoretical and Experimentally Measured Values of Particle
Hydrodynamic Velocity at a Particle-Surface Separation
Distance of 500 Å

| | Distance | | | |
|---|---|---|---|---|
| | along the | Shear | Hydrodynamic | Experimentally |
| | channel | stress | velocity* | measured rolling |
| Permeation | (cm) | (dyn/cm²) | (μm/s) | velocity (μm/s) |
| 50% | 0 | 5 | 1000 | — |
| | 1 | 4.4 | 880 | 854 ± 74 |
| | 2 | 3.8 | 760 | 716 ± 63 |
| | 3 | 3.2 | 640 | 601 ± 39- |
| | 4 | 2.5 | 500 | |
| 60% | 0 | 5 | — | — |
| | 1 | 4.2 | 840 | 686 ± 56 |
| | 2 | 3.5 | 700 | 489 ± 46 |
| | 3 | 2.8 | 560 | 388 ± 14 |
| | 4 | 2 | | — |
| 70% | 0 | 5 | — | — |
| | 1 | 4.1 | 810 | 538 ± 27 |
| | 2 | 3.3 | 660 | 318 ± 5 |
| | 3 | 2.4 | 480 | 118 ± 3 |
| | 4 | 1.5 | 300 | — |
| 80% | 0 | 5 | 1000 | — |
| | 1 | 4 | 800 | 420 ± 24 |
| | 2 | 3 | 600 | 210 ± 15 |
| | 3 | 2 | 400 | 0 |
| | 4 | 1 | 200 | 0 |

### Example 4

### Determining Device Operating Point

Even though the residence volume of the device used for the experiments was 8 μl (1:4 cm, w:2 mm, h:100 μm), we processed 1 mL sample volumes through the device, which was very large compared to the device volume. With a small operating device volume, we made sure that the device operated optimally in steady state so that only the specific PC3 cells interacted with the EpCAM coated antibody and were captured, whereas the rest were sheared away. While the particle volume fraction and permeation flux together defined the rate of deposition of cells onto the porous membrane, the dimensions of the channel and the inlet flow rate defined the shear that swept the particles along the membrane.

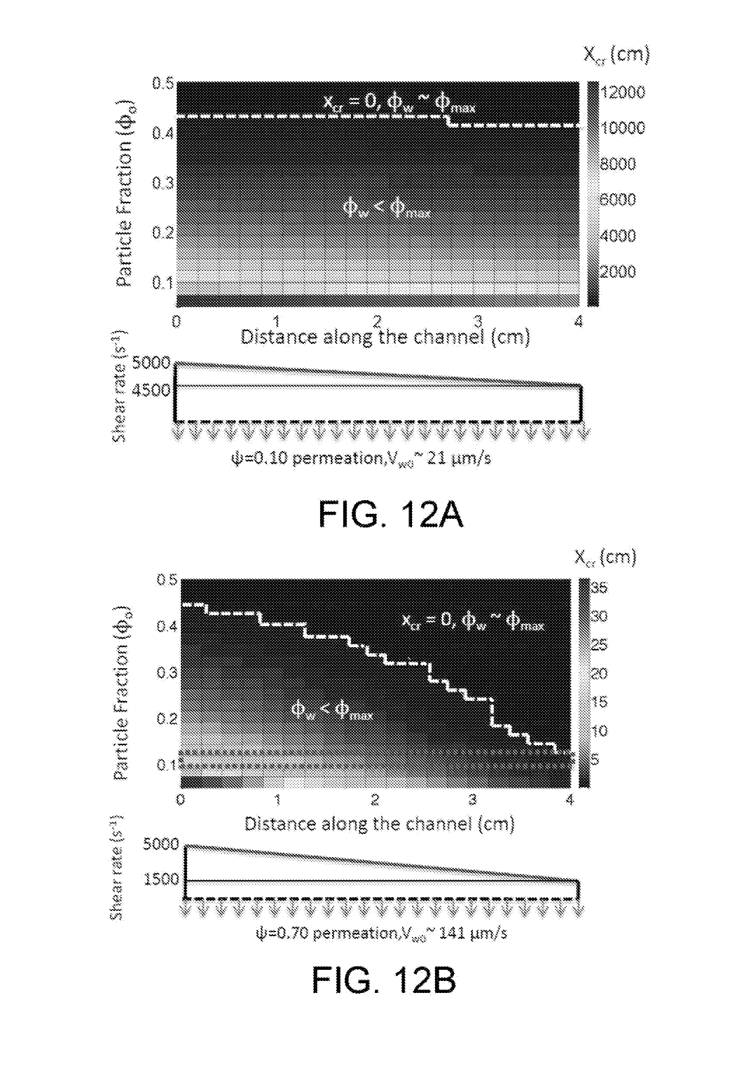

The operating point of the device can be such that the rate at which maximum number of cells are brought to the surface from the bulk is about equal to the rate at which they are sheared across the length of the device, in order to avoid particle buildup at any location on the porous surface and therefore reduced performance of the porous surface over time. We identified three key factors that dictate cell convection to the porous surface and cell translation along the porous surface: (a) Input particle volume fraction, φₒ, (b) the permeation flux through the membrane and (c) shear rate at the wall, \dot{y}. State diagrams of the critical distance, x_{cr}, along the channel at which the feed cell volume fraction at the inlet, φₒ reaches its maximum packing density at the porous wall are shown in FIGS. 12A and 12B.

Since the goal was to increase the throughput of the sample, high φₒ, was desired. However from FIG. 12A we see that as φₒ, increased (>1.5), the maximum packing density of the cells was reached earlier on in the channel length, which precluded function of the device over longer time spans and large volumes. Simultaneously, we see from FIG. 12A and FIG. 12B that the permeation ψ had a significant effect on where along the length of the channel the critical distance, x_{cr}=0, was reached.

Keeping the above consideration in mind we defined the experimental operating point chosen based on FIG. 12A and allowed the device to process greater than 1 mL of sample under the following operating conditions: φₒ=0.1, permeation ψ=70%, flux out of the device Qₒ=100 μl/min, L=4 cm, w=2 mm, h=100 μm.

### Example 5

### Capture Efficiency

To evaluate cell capture efficiency for porous and non-porous devices, 2000 CTO labeled cells were spiked in 1 mL of buffer and the sample was injected into each device using a constant pressure pump with a rocking syringe holder. The inlet pressure was set to flow the sample at 100 μl/min through the device based on equation S.4 and equation S.5. The output tubing resistances were adjusted for each condition of percentage fluid flux through the porous surface. Each channel was imaged and videos were taken at the end of the channel for each condition to calculate total number of cells convected to the surface. The total fraction of cells convected to the surface was calculated as total number of cells convected to the surface (sum of the number of particles attached to the porous surface and the cells moving out of the channel at the end of the surface) and the total number of cells that were put into the device. Referring again to FIG. 9, we see there was a linear relationship between the percentage of fluid permeating through the membrane and the fraction of cells convected to the membrane for porous surface with pore sizes of 200 nm and 1.2 μm.

The performance of the porous surface and the solid flat surfaces were evaluated by the percentage capture of specific cells from the input sample. The capture efficiency was calculated using equation

$$Fractional Cell Capture Efficiency = \frac{{N}_{b}}{{N}_{b} + {N}_{out}} \qquad ( 1 )$$

Where N_{b} is the number of cells bound to the membrane surface and Nₒᵤₜ is the number of cells exiting the device. The concentration of PC3 cells in the input sample was calculated before every experiment and a mass balance was performed. Less than 5% of the cells were not accounted for, which could be due to counting errors.

To compare the capture efficiency of the two surfaces (i.e., porous vs. non-porous) based on the operating conditions described in the above sections, we performed the experiment with polystyrene beads coated with Prostate cancer cells and Biotinilated polystyrene beads on surfaces that were covalently functionalized with EpCAM antibody and Avidin respectively. In both scenarios, there was a drop close to 0% capture efficiency on the solid flat surface at a relatively low flow rate (25 μl/min). In contrast, the capture efficiency was maintained at 65% with a standard deviation of 10% on the porous surfaces. The capture efficiency on the porous surface decreased significantly with the increase in flow rate above 100 μl/min.

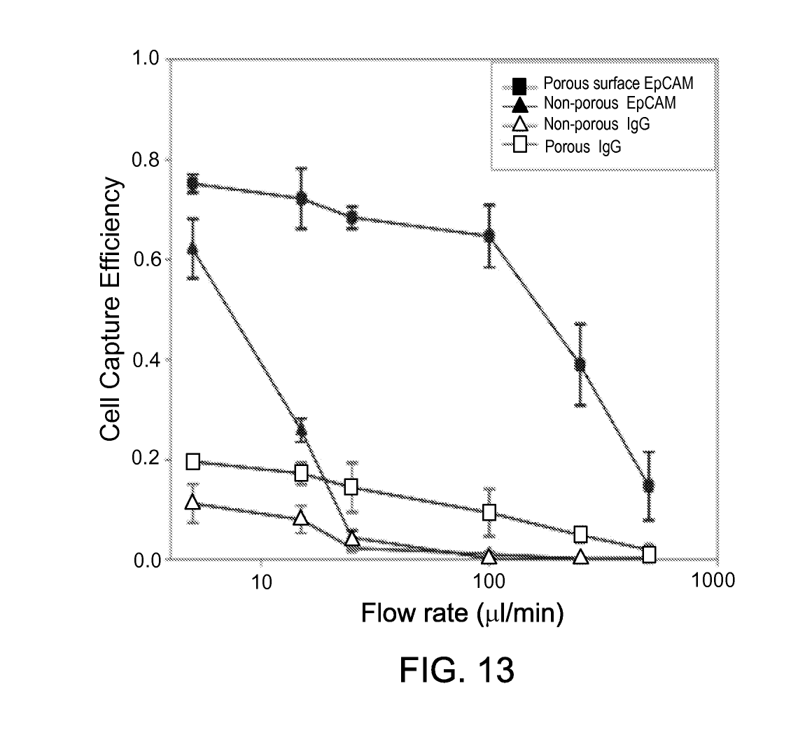

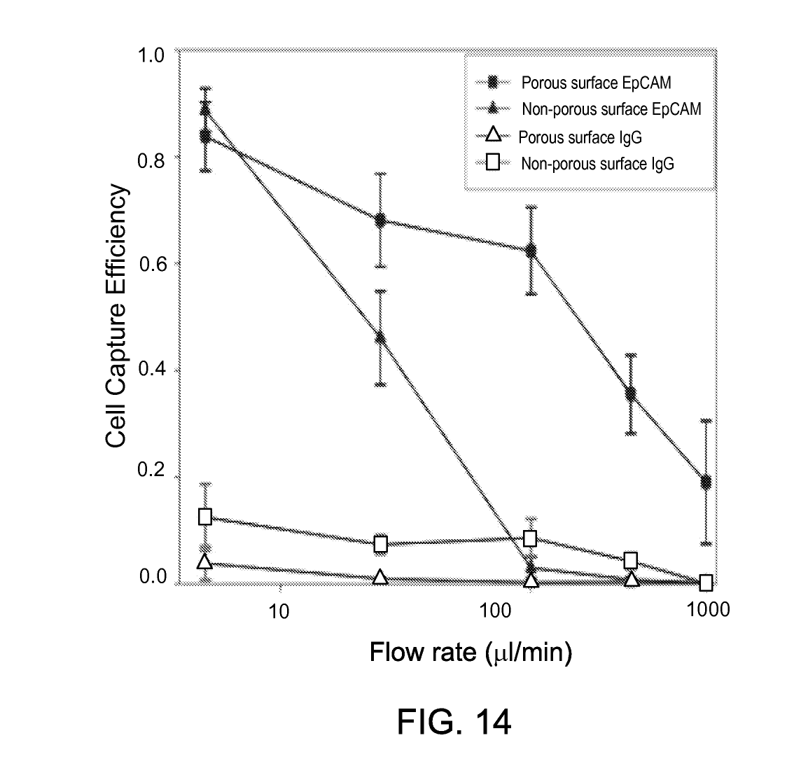

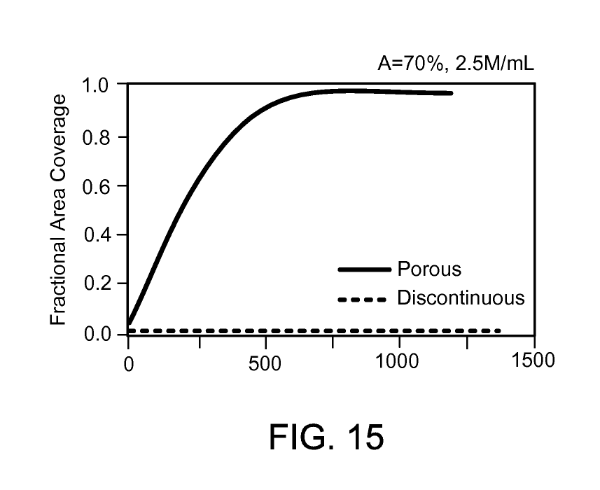

FIG. 13 is a graph of cell capture efficiency for prostate cancer cells (PC3) in buffy coat at 70% permeation versus inlet flow rate. FIG. 14 is a graph of cell capture efficiency for biotinylated polymer beads in buffy coat versus inlet flow rate. IgG controls were used to characterize the specificity of the cell capture. IgG controls on the porous and solid flat surfaces showed ˜6-7 fold reduction in capture indicating that the capture of the cells on the surface was mostly specific to the interaction between the complimentary molecules.

As a result of these experiments, we experimentally substantiated the enhanced specific cell capture efficiency on complimentary antibody functionalized porous surface over its solid counterpart at high flow rates. We identified that at high flow rates the permeation flux through the membrane is not only responsible for increasing the interaction of cells with the porous surface, but under the optimal shear rate to porous wall velocity ratio, the cells on the surface experience a jerky stop-and-go motion. The axial shear translated the cells along the porous surface, whereas the transverse wall velocity temporarily stopped these cells under shear. The stop and go motion allowed the EpCAM antigen and the complimentary Anti-EpCAM on the surface to interact under near zero shear conditions, even at high average bulk flow velocities.

To reliably achieve the optimal shear rate to wall velocity ratio, we first made sure that we were able to reliably achieve similar inlet flow rate split to the top channel and through the membrane. Because commercially available track etched porous membranes have inherent variability in the porosity, we observed that fluid permeation through the membrane and hence the dependent number of cells that interact with the surface varied with different devices. On average, a 30%-40% change in permeation flux through the membranes was measured due to porosity differences of the polycarbonate membranes. To remove the percentage permeation flux variations and quantify the performance of the device reproducibly, large resistive tubings (100 μm diameter) added at the outlets of the top and bottom channels helped “short” out any variations in the membrane and insured constant permeation flux along the length of the membrane. The lumped resistive model accurately predicted the fluid split between the top and the bottom channels was a function of the sample input pressure when the tubing resistances were approximately ten times the fluidic resistance of the membrane and the channels in a sample with dilute suspension of particles (φo<0.1). We found that, the ratio of the resistances on the top and bottom tubing determined the fluid split, whereas the actual resistances of the tubing determined the sample flow rate through the top and bottom outlets of the channels.

Additionally, we observed that for similar conditions of input cell volume fraction φo and percentage porous flux through the membrane, ψ, the fraction of particles that interacted with the surface was similar for different membrane pore sizes. For our experiments we chose membrane with rₚ=100 nm, so that they were big enough to let fluid through under a reasonable pressure difference (˜5 Psig), but small enough to preclude cell passage or physical trapping of the cells.

A comparison between two devices of same dimensions (L=4 cm, w=2 mm, h=100 μm) with a flat surface as opposed to a porous surface showed that at flow rates greater than 25 μl/min, the fraction of cells interacting with a porous surface depended in a linear manner with ψ but did not interact with the flat surface. However, the wall velocity, Vwo, that biased the cells to the surface was also responsible for reduced axial motion of the cells along the surface. Therefore, in order for the device to be able to continuously process large volumes of sample at high flow rate in steady state, we defined the device operating point as a function of ψ and input feed cell volume fraction φo. The operating point of the device required that the rate at which cells were brought to the porous surface at a location should be about equal to the rate at which all the cells on the surface upstream of that location were sheared past that location. Critical distance, gives us the location at which the above condition is not met. The operating point in order to maximize the throughput of the device was set at φₒ=0.1, ψ=70%, Qₒ=100 μl/min, L=4 cm, w=2 mm, h=100 μm.

As a cell moved along the porous surface, the cell velocity decreased along the length of the channel because of a constant permeation flux through the membrane. Initially the inlet sample flow rate was set equal to 100 μl/min. Under the operating conditions mentioned earlier, we observed that the increase percentage permeation flux increased (>60%) and led to an increasing deviation from the theoretical cell velocity. This suggested that as permeation flux increases, the local fluid fields around the cell become increasingly important to ascertain the motion of cells along the porous surface. We observed a stop-and-go motion of the cells on the porous surface for ψ=0.7. Cell capture took place where the shear rate (s⁻¹) to wall velocity (μm/s) ratio fell between 13 and 26 which occurs between 1.5 cm and 3.5 cm along the length of the channel.

We have demonstrated an s significant increase in specific cell capture on a porous surface functionalized with specific antibodies over its solid counterpart. At flow rates of 25 μl/min, the capture efficiency of the PC3 cells fell precipitously on the flat solid surface to 5%, whereas the capture efficiency on a porous surface was maintained at 70% for flow rates at 100 μl/min. Additionally, the non-target cell binding (Buffy coat cells) at high flow rates of 100 μl/min was low (˜10%), indicating that the buffy coat cells were sheared away. Therefore, we can attribute the significantly higher capture efficiency on the porous surface due to increased cell surface interaction, increased near-zero instantaneous shear rate conditions along the porous surface and decreasing shear stress and cell velocities along the length of the channel.

### Example 6

### Cell Capture Using a Discontinuously Permeable Membrane

The microfluidic device described with reference to this example was manufactured using a polycarbonate membrane (200 nm pores, 10% porosity, 10 mm thick) sandwiched between two PDMS layers. As described above, each layer can be replica-molded from a silicon master with SU-8 features using standard soft lithography techniques. Top and bottom layers can include an independent inlet and outlet connected by a rectangular channel 100 mm or 250 mm high, 2 mm wide, and 4 cm long. For capture surfaces with discontinuous permeability, the lower channel can be 1.4 mm wide. The membranes can be covalently functionalized with anti-EpCAM or anti-IgG (30 mg/mL) using techniques described above.

The sample analyzed using this microfluidic device was prepared as described below. Leukocytes (buffy coat) were isolated from whole blood at a concentration of 2.5M/mL via deterministic lateral displacement and fluorescently labeled (CellTrace Calcein Green; Invitrogen, Carlsbad, Calif.). PC3-9, PC3 and H1650 (ATCC) were cultured at 37° C. and 5% CO2 in F-12K growth media containing 1.5 mM L-glutamine supplemented with 10% FBS and 1% Penicillin/Streptomycin, with media changes every 2-3 days. These cells were labeled with a different fluorescent dye (Cell Tracker Orange, Invitrogen, Carlsbad, Calif.) and spiked into the sample at various ratios. The spike count was verified immediately before addition to the buffy coat population as well as before loading the sample into the device.

The microfluidic device described with reference to this example can be operated as described below. Samples were loaded into a 60 mL syringe, and a constant pressure syringe pump was used to apply a constant flow through the top inlet while the bottom inlet was closed. The top and bottom outlets were both open, and the ratio of transverse membrane flux and axial channel flux was regulated by means of the relative resistances of the outlet tubing. Cell capture was visualized with an upright epifluorescence microscope (Nikon Eclipse 90i) using a 4× (Nikon Plan Fluor, NA 1/4 0.13) or at 1 frame per second with a CCD camera (QImaging Retiga 2000R).

Images obtained by operating the microfluidic device described with reference to this example can be analyzed as described below. Gray scale images of accumulated fluorescent cells were analyzed using image analysis functions in MATLAB®. Images were thresholded to binary images using known methods, for example, Otsu's method. Threshold values were recomputed for every image to compensate for photobleaching and manually verified. The total area coverage was determined using a pattern-weighted formula that accounts for distortions due to pixel biasing. Kymographs were generated by integrating pixel intensities across the length of the image to generate a cross-sectional average, then stacking these cross-sections in sequential order.

As described above, for porous membranes such as those described with reference to FIG. 1B, caking was observed initially at the channel edges and growing inward over time. In such porous membranes, target capture was suppressed at increased background cell concentrations. To characterize the suppression, PC3 cancel cells were spiked at controlled concentrations from 5/mL to 5,000/mL into a heterogeneous population of white blood cells (“buffy coat”) at concentrations ranging from 5,000 mL to 5M/mL. By operating the devices at 6 mL/hr with 70% fluid flux being diverted to the capture surface and subsequently scanning the capture surface with an upright fluorescence microscope, a target capture efficiency of −70% was determined for background cell concentrations up to 0.5 M/mL. It was observed that when the background cell concentration was 2.5 M/mL, the target capture efficiency was decreased to 30% or less.

To verify that the diminished target capture occurred due to surface fouling, a solution comprised only of white blood cells was introduced to partially cover the surface. The area coverage was quantified by thresholding the fluorescent image and then applying a pattern-weighted algorithm that compensated for pixel biasing. A solution of target cells and white blood cells was then added and the final capture efficiency was determined. When the white blood cells occupied ˜50% or less of the capture surface, the capture efficiency remained largely unaffected at ˜70%. However, the capture efficiency was reduced to ˜50% for 70% coverage and fell to less than 10% at 90% coverage. This sharp drop-off in capture efficiency at increased area coverage is qualitatively consistent with the suppression observed at increased bulk cell concentrations. Nevertheless, a crucial difference between these two experiments is that target capture initially occurred on a pristine, unfouled surface, with non-specific cake formation occurring simultaneously. Thus, the relative kinetics of these two processes may be more relevant than the final steady state coverage.

In the experimental conditions described with reference to this example, cake layer formation was initiated through heterogeneous nucleation from the channel edges, even at relatively low cell concentrations and permeation flux. The critical island diameter appeared to be ˜500 μm, after which they became immobile barriers that collected incoming cells by blocking their motion across the surface. In contrast, some homogeneous nucleation was observed across the center of the channel, but these islands tended to remain small (diameter <100 μm) and grew slowly. Over time, these islands grew inwards towards the center of the channel, eventually reaching a steady state coverage.

It was determined that cake layer formation is governed by the flux of cells being cleared from the surface by shear forces. Ordinarily, this shear does not exhibit significant lateral variation when the channel width is considerably larger than the height. However, in the microfluidic channels used in this example, the width was comparable to the height, with a ratio W/H˜20. A calculation of the local shear conditions for solid channels indicated a decrease of 30% within ˜300 μm of the edges. For fluid permeable surfaces, where a significant fraction of the streamlines were diverted, the shear near the edges was reduced by a total of 80%. This five-fold decrease in shear near the edge translates into a severely diminished clearance of accumulated cells and local cake formation, which is consistent with the roughly five-fold difference in deposition rates.

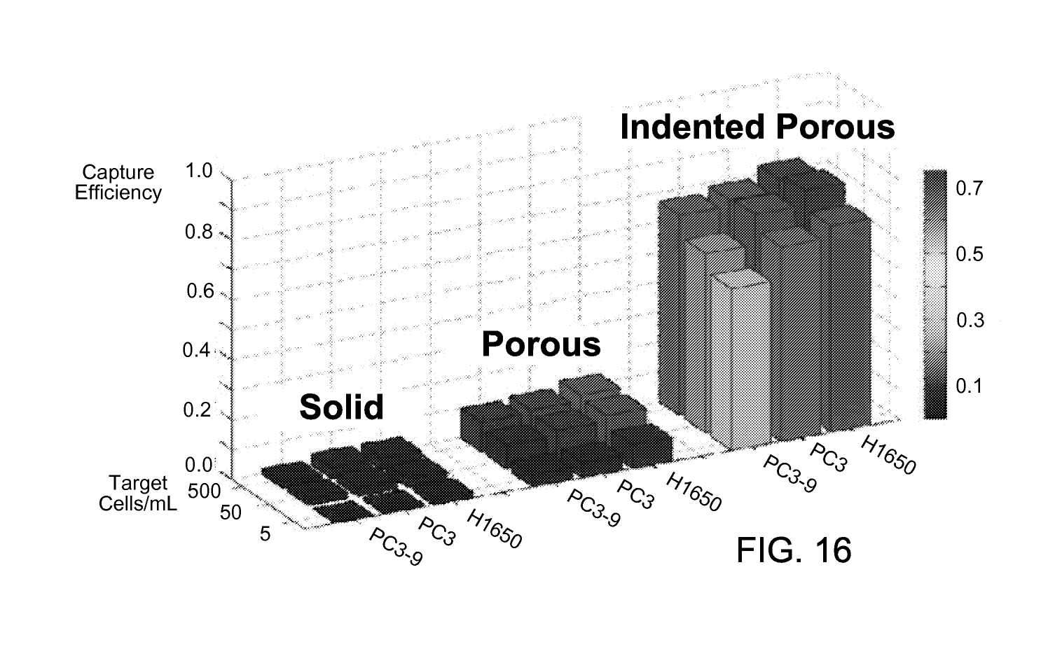

By combining porous channels with solid channels to engineer a capture surface with discontinuous permeability (FIG. 1C), the edge effects were overcome. To engineer such a membrane, the design of the microfluidic device was modified so that the upper channel was approximately 600 μm wider than the lower channel. As a result, once the nanoporous membrane was sandwiched between these two sections, the protruding walls of the lower channel rendered the membrane impermeable within ˜300 μm of each wall in the upper channel. Compared to a porous membrane, a discontinuously porous membrane exhibited better suppression of cake layer formation even for conditions of high cell concentrations and permeation flux (FIG. 15). The microfluidic device described with reference to this example can be implemented in multiplexed devices for high-throughput cell sorting. FIG. 16 is a graph showing capture efficiencies for cancer cell lines (PC3-9, PC3 and H1650) spiked at concentrations of 5/mL to 500/mL in undiluted buffy coat (2/5 M/mL).

### OTHER EMBODIMENTS

It is to be understood that while the invention has been described, the foregoing description is intended to illustrate and not to limit the scope of the invention, which is defined by the scope of the appended claims. Other aspects, advantages, and modifications are within the scope of the following claims.

1-15. (canceled)

16. A method for capturing particles, the method comprising:
introducing a fluid sample into a first channel of a microfluidic device,
wherein the fluid sample includes a plurality of particles of a first type;
flowing the fluid sample past a porous membrane, wherein the porous membrane includes a plurality of pores, at least some of the pores fluidly connecting the first channel to a second channel; and
a plurality of binding moieties bound on a first side of the porous membrane adjacent to the first channel, where the plurality of binding moieties are capable of binding to the plurality of particles of a first type;
creating a pressure difference between the first channel and the second channel to allow the fluid sample to flow from the first channel through the porous membrane into the second channel and to direct the plurality of particles toward the plurality of binding moieties; and
capturing the plurality of particles of the first type on the plurality of binding moieties.

17. The method of claim 16, wherein creating the pressure difference between the first channel and the second channel comprises opening an outlet in the second channel.

18. The method of claim 17, wherein creating the pressure difference between the first channel and the second channel comprises opening an outlet in the first channel.

19. The method of claim 18, wherein creating the pressure difference comprises adjusting a size of the outlet in the second channel to be smaller than a size of the outlet in the first channel.

20. The method of claim 16, wherein capturing the plurality of particles of the first type comprises allowing the plurality of particles of the first type to bind to the plurality of binding moieties on the first side of the porous membrane.

21. The method of claim 16, further comprising:
introducing a washing sample into the first channel of the microfluidic device;
flowing the washing sample past the porous membrane; and
preventing the washing sample from flowing through the porous membrane into the second channel.

22. The method of claim 21, wherein preventing the washing sample from flowing through the porous membrane comprises closing an outlet in the second channel.

23. The method of claim 16, wherein a size of each particle of the first type is larger than a size of each pore.

24. The method of claim 16, wherein the fluid sample further includes a plurality of particle of a second type.

25. The method of claim 24, further comprising allowing the plurality of particles of the second type to pass from the first channel through the porous membrane into the second channel.

26. The method of claim 25, wherein a size of each particle of the second type is smaller than a size of each pore.

27. The method of claim 16, wherein the porous membrane is a discontinuously permeable porous membrane.

28. (canceled)
